(19) United States
(12) Patent Application Publication
(10) Pub. No.: US 2026/0153966 A1
(43) Pub. Date: Jun. 4, 2026

(54) DISPLAY APPARATUS INCLUDING TOUCH ELECTRODE WITH SEPARATION AREA AND ELECTRONIC DEVICE COMPRISING SAME

(71) Applicant: SAMSUNG DISPLAY CO., LTD., YONGIN-SI (KR)

(72) Inventors: TAE YONG EOM, Yongin-si (KR); MOOJONG KIM, Yongin-si (KR)

(21) Appl. No.: 19/384,719

(22) Filed: Nov. 10, 2025

(30) Foreign Application Priority Data
Dec. 3, 2024 (KR) 10-2024-0177944

(51) Int. Cl. G06F 3/044; G06F 3/041; G09G 3/3233

(52) U.S. Cl. CPC G06F 3/0448; G06F 3/0412; G06F 3/0446; G06F 2203/04111; G06F 2203/04112; G09G 3/3233; G09G 2300/0819; G09G 2300/0842; G09G 2354/00

(57) ABSTRACT

A display apparatus includes a plurality of emission areas configured to emit light, and a touch electrode arranged to sense a touch. The touch electrode includes a first extension area extending primarily in a first direction, a second extension area extending primarily in a second direction crossing the first direction, a connection area in which the first extension area and the second extension area are connected, and a separation area that is free of a material of the touch electrode. The separation area is closer to the connection area than to a center of the first extension area or the second extension area in a longitudinal direction of the first extension area or the second extension area.

### CROSS-REFERENCE TO RELATED APPLICATION

This application claims priority under 35 U.S.C. §119 to Korean Patent Application No. 10-2024-0177944, filed on December 3, 2024, in the Korean Intellectual Property Office, the disclosure of which is incorporated by reference herein in its entirety.

### TECHNICAL FIELD

The present disclosure relates to a display apparatus and, more specifically, to a display apparatus including a touch electrode with a separation area and an electronic device including the same.

### DISCUSSION OF THE RELATED ART

Recently, display devices have been used in a wider range of electronic devices as they have become thinner and lighter weight.

With advances in display technology, these devices are now capable of offering increased functionality. For example, many displays now incorporate or operate alongside touch sensing units which recognize a user input.

As a result, display devices are used in a wide variety of products that go beyond TV sets and computer monitors, and also include mobile phones, tablet computers, smartwatches, digital signage, and other user wearable devices.

Accordingly, there is a growing demand for display devices that deliver higher image quality across diverse environments.

### SUMMARY

A display apparatus includes a plurality of emission areas configured to emit light, and a touch electrode configured to sense a touch. The touch electrode includes a first extension area extending primarily in a first direction, a second extension area extending primarily in a direction crossing the first direction, a connection area in which the first extension area and the second extension area are connected, and a separation area, free of a material of the touch electrode. The separation area is closer to the connection area than to a center of the first extension area or the second extension area in a longitudinal direction of the first extension area or the second extension area.

The separation area may be disposed between either the first extension area or the second extension area, and the connection area.

The separation area may be disposed in the connection area.

The connection area may include a curved portion.

The separation area may overlap the curved portion.

The connection area may be provided in plural, and may include a curved portion formed to oppose the separation area which overlaps the curved portion.

The touch electrode may have a mesh shape that corresponds to a periphery of each of the plurality of emission areas.

A display apparatus includes a display panel and a touch sensing unit. The display panel includes at least one display component configured to generate an image. The touch sensing unit includes a touch electrode configured to sense a touch. The touch electrode includes a first extension area extending primarily in a first direction, a second extension area extending primarily in a direction crossing the first direction, a connection area in which the first extension area and the second extension area are connected, and a separation area, free of a material of the touch electrode, the separation area being closer to the connection area than to a center of the first extension area or the second extension area in a longitudinal direction of the first extension area or the second extension area.

The separation area may be disposed between either the first extension area or the second extension area, and the connection area.

The separation area may be disposed in the connection area.

The connection area may include a curved portion.

The separation area may overlap the curved portion.

The connection area may be provided in plural, and the connection area may include a curved portion opposite to the separation area, which overlaps the curved portion.

The touch electrode may have a mesh shape corresponding to a periphery of each of a plurality of emission areas of the display panel.

The touch sensing unit may be disposed on the display panel.

An electronic device includes a processor configured to execute at least one application by sensing an external input through a sensor module, and a display panel configured to display at least one image by the control of the processor. The display panel includes at least one display component configured to generate an image. The sensor module includes a touch sensing unit configured to sense a touch. The touch sensing unit includes a touch electrode configured to sense the touch. The touch electrode includes a first extension area extending primarily in a first direction, a second extension area extending primarily in a second direction, crossing the first direction, a connection area in which the first extension area and the second extension area are connected to each other, and a separation area, free of a material of the touch electrode, the separation area being closer to the connection area than to either a center of the first extension area or the second extension area in a longitudinal direction of the first extension area or the second extension area.

The separation area may be disposed between either the first extension area or the second extension area, and the connection area.

The separation area may be disposed in the connection area.

The connection area may include a curved portion.

The touch sensing unit may be disposed on the display panel.

### BRIEF DESCRIPTION OF THE DRAWINGS

These and/or other aspects will become apparent and more readily appreciated from the following description of the embodiments, taken in conjunction with the accompanying drawings in which:

FIG. 1 is a plan view of a display apparatus according to an embodiment;

FIG. 2 is an enlarged plan view of an area K of FIG. 1;

FIG. 3 is an enlarged plan view of a modified example of FIG. 2;

FIG. 4 is a plan view of a display apparatus according to an embodiment;

FIG. 5 is a cross-sectional view of the display apparatus of FIG. 4;

FIG. 6 is a cross-sectional view of a display module of the display apparatus of FIG. 4;

FIG. 7 is a plan view of a display panel of the display apparatus of FIG. 4;

FIG. 8 is an equivalent circuit diagram of a pixel of the display apparatus of FIG. 4;

FIGS. 9 and 10 are cross-sectional views of the display panel of the display apparatus of FIG. 4;

FIG. 11 is a plan view of a touch sensing unit of the display apparatus of FIG. 4;

FIG. 12 is an enlarged plan view of an area A of FIG. 11;

FIG. 13 is an enlarged plan view of an area B of FIG. 12;

FIG. 14 is diagram illustrating an electronic device to which a display apparatus according to an embodiment is applied;

FIG. 15 is a perspective view illustrating an electronic device to which a display apparatus according to an embodiment is applied;

FIGS. 16 and 17 are perspective views illustrating an electronic device to which a display apparatus according to an embodiment is applied; and

FIG. 18 is a perspective view illustrating an electronic device to which a display apparatus according to an embodiment is applied.

### DETAILED DESCRIPTION OF THE DRAWINGS

As the disclosure allows for various changes and numerous embodiments, certain embodiments will be illustrated in the drawings and described in detail in the written description. Effects and features of the disclosure, and methods of achieving them will be clarified with reference to embodiments described below in detail with reference to the drawings. However, the disclosure is not necessarily limited to the following embodiments and may be embodied in various forms.

In the following embodiments, the terms "first," "second," and the like are not necessarily used in a restrictive sense and are used to distinguish one component from another.

The singular forms as used herein are intended to include the plural forms as well unless the context clearly indicates otherwise.

It will be further understood that the terms "include" and/or "comprise" used herein specify the presence of stated features or components, but do not necessarily preclude the presence or addition of one or more other features or components.

In the following embodiments, it will be understood that, when a portion such as a layer, region, or component is referred to as being "on" another portion, this may include not only a case where the portion is directly on the other portion, but also a case where intervening layers, regions, or components may be present therebetween.

While each drawing may represent one or more particular embodiments of the present disclosure, drawn to scale, such that the relative lengths, thicknesses, and angles can be inferred therefrom, it is to be understood that the present invention is not necessarily limited to the relative lengths, thicknesses, and angles shown. Changes to these values may be made within the spirit and scope of the present disclosure, for example, to allow for manufacturing limitations and the like.

In the following examples, an x-axis, a y-axis, and a z-axis are not necessarily limited to three axes of the Cartesian coordinate system, and may be interpreted in a broader sense. For example, the x-axis, the y-axis, and the z-axis may be perpendicular to one another, or may represent different directions that are not necessarily perpendicular to one another.

A specific process order may be performed differently from the described order in case where a certain embodiment may be implemented differently. For example, two processes described in succession may be performed substantially at the same time or may be performed in a reverse order opposite to that described.

Hereinafter, embodiments will be described in detail with reference to the accompanying drawings. When describing embodiments with reference to the accompanying drawings, the same or corresponding components may be denoted by the same reference numeral, and to the extent that a component is not described in detail with respect to this figure, it may be understood that the component is at least similar to a corresponding component that has been described elsewhere within the present disclosure.

Embodiments of the present disclosure pertains to a novel configuration of a touch electrode structure for a display apparatus, designed to reduce the visibility of spot artifacts caused by external light reflection. This is achieved through the introduction of a unique separation area within the mesh-shaped layout of the touch electrode.

According to this approach, the touch electrode includes a first extension area and a second extension area arranged in intersecting directions. These areas are connected by a connection area, which may have a curved shape. An innovation is the placement of the separation area—an intentional gap or cutout in the electrode material—adjacent to or within the connection area rather than randomly in the main extension zones. By localizing the separation area near parts of the electrode structure that naturally have lower light reflectivity (e.g., the curved connection area), the design significantly reduces visible artifacts, such as bright spots or pattern irregularities, that might otherwise result when external light reflects off the regular mesh pattern of the electrode.

This allows the display to maintain higher image quality even under strong ambient lighting, which is especially important for mobile or outdoor-use devices. This also accounts for the electrical integrity of the mesh by ensuring that these separation areas are positioned and shaped in ways that minimize their impact on signal continuity and touch sensing performance.

Furthermore, embodiments of the present disclosure may make use of a modular layout, where unit areas with identical or complementary configurations of separation areas are repeated across the display. This modularization ensures uniform optical and touch performance across the entire panel. In some embodiments, the mesh pattern of the touch electrodes may also be slightly tilted relative to the pixel arrangement to further disperse reflected light and avoid uniform reflection patterns that cause visible moiré or spot effects.

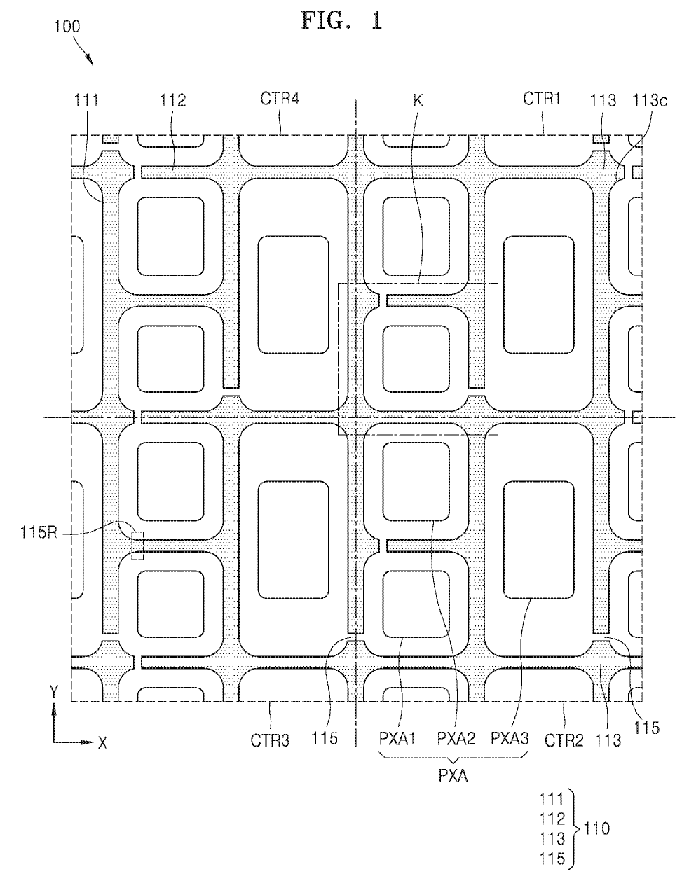

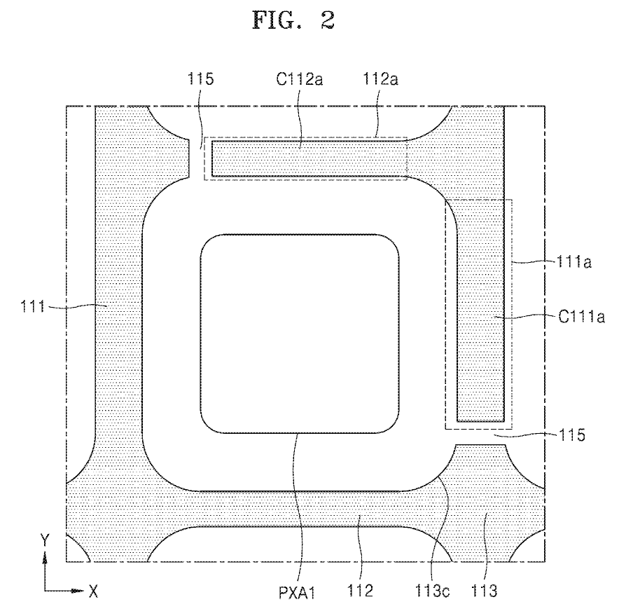

FIG. 1 is a plan view of a portion of a display apparatus according to an embodiment. FIG. 2 is a schematic enlarged view of a region K of FIG. 1.

The display apparatus 100 may include a plurality of emission areas PXA1, PXA2, and PXA3, which may be referred to collectively as PXA, and a touch electrode 110.

The plurality of emission areas PXA1, PXA2, and PXA3 may be areas where user-recognizable light is emitted from, and for example, may each emit light of a different color. In some examples, the first emission area PXA1 may emit red light, the second emission area PXA2 may emit green light, and the third emission area PXA3 may emit blue light.

As an optional embodiment, the plurality of emission areas PXA1, PXA2, and PXA3 may emit light of the same color, for example, blue light.

The first emission area PXA1, the second emission area PXA2, and the third emission area PXA3 may be implemented in a shape similar to a rectangle, which may be implemented by controlling a shape of an emission layer or by utilizing a pattern of an opening of an insulating layer arranged on the emission layer.

As an optional embodiment, the sizes and shapes of the first emission area PXA1, the second emission area PXA2, and the third emission area PXA3 may be controlled in various ways, and for example, as illustrated in FIG. 1, the third emission area PXA3 may be larger than the first emission area PXA1 and the second emission area PXA2 so that blue light may be smoothly utilized for implementing an image.

In some examples, the touch electrode 110 may include various conductive materials, for example, a transparent conductive material, such as, conductive oxide. The touch electrode 110 may also include a metal material.

The touch electrode 110 may include a first extension area 111 and a second extension area 112 extending in a direction crossing a direction of extension of the first extension area 111.

The first extension area 111 may have a shape extending primarily in a first direction (for example, a Y-axis direction of FIG. 1), and the second extension area 112 may have a shape extending primarily in a second direction which crosses or is orthogonal to the first direction (for example, an X-axis direction of FIG. 1 which is orthogonal to the first direction). As used herein, the phrase “extending primarily in a given direction” means that while the shape may be two or three-dimensional and may extend in multiple directions, it extends to the greatest extent in the given direction.

The first extension area 111 may be provided in plural and spaced apart from each other with a gap in the second direction (e.g., the X-axis direction of FIG. 1). The second extension area 112 may also be provided in plural and spaced apart from each other with a gap in the first direction (e.g., the Y-axis direction of FIG. 1).

The first extension area 111 and the second extension area 112 of the touch electrode 110 may correspond to a periphery of each of the plurality of emission areas.

A separation area 115 may be an area where a conductive material for the touch electrode 110 is not formed or cut out, and may be formed by cutting one area of the first extension area 111 or the second extension area 112 in an extension direction of the first extension area 111 or the second extension area 112.

The separation area 115 may be closer to a connection area 113 than to a center of an area, which is located between opposite connection areas 113, of the first extension area 111, for example, a center of a main area of the first extension area 111 in a longitudinal direction of the first extension area 111. For example, as depicted in FIG. 2, one separation area 115 (bottom right) is closer to a connection area 113 directly below it than to a center C111a of a first extension area 111a. Another separation area 115 (top left) is closer to a connection area 113 (directly to the left) than to a center C112a of a second extension area 112a.

In a specific example, the separation area 115 may be formed between the first extension area 111 and the connection area 113, and as an optional embodiment, may include an area of the connection area 113.

In an example, the separation area 115 may be closer to the connection area 113 than to a center of an area, which is between opposite connection areas 113, of the second extension area 112, for example, a center of a main area of the second extension area 112 in a longitudinal direction of the second extension area 112.

In a specific example, the separation area 115 may be formed between the second extension area 112 and the connection area 113, and as an optional embodiment, may include an area of the connection area 113.

As an example, the separation area 115 may correspond to an area of the connection area 113.

The touch electrode 110 may be configured to sense a touch, such as a touch of a user by finger or stylus/pen, and may be configured, for example, to detect a change in electrostatic capacitance when the user applies a touch input. As a specific example, the touch electrode 110 may include an electrode for driving and an electrode for sensing. When the touch electrode 110 includes the electrode for driving and the electrode for sensing, the two electrodes may be arranged on the same plane, and as a specific example, may have areas spaced apart from each other. The user may visibly recognize spots through the spaced area. In the embodiment disclosed herein, the touch electrode 110 may include the plurality of separation areas 115 to reduce or suppress the visible recognition of the spots.

In some examples, the touch electrode 110 may include various conductive materials, for example, a transparent conductive material, as a specific example, conductive oxide. The touch electrode 110 may also include a metal material.

The touch electrode 110 may include a plurality of first extension areas 111 and a plurality of second extension areas 112 in a mesh structure, for example, may include first extension areas 111 and second extension areas 112 that are electrically connected to each other in a mesh structure.

In some embodiments, external light may be reflected in at least one area when the external light is incident on the first extension area 111 and the second extension area 112, for example, may be reflected in an area adjacent to an edge and may be recognized by the user. When there is an irregular arrangement in the regular mesh-shaped arrangement, there may be more reflected light.

In some embodiments, reflection might not occur and reflected external light might not be recognized in the plurality of separation areas 115. The areas where no external light reflection occurs may act as irregular disconnections (interruptions) in terms of reflection characteristics through the regular mesh-shaped structure, and the user may sense spot patterns when external light is reflected. In the embodiment disclosed herein, the separation area 115 may be formed adjacent to the connection area 113 or in an area of the connection area 113 to reduce or suppress the generation of spots due to external light. For example, the connection area 113 may be an area where external light is not reflected well when incident, compared to the first extension area 111 and the second extension area 112, and thus external light reflection visibility is low. The connection area 113 may be an area with a regular arrangement in the mesh structure.

Therefore, when the separation area 115 is adjacent to the connection area 113 or corresponds to the connection area 113, the occurrence of spots (bruising), which is caused by the disconnection of an external light reflection area in the first extension area 111 and the second extension area 112 due to the separation area 115, may be reduced or suppressed.

The connection area 113 may also include a curved portion 113C, and the separation area 115 may correspond to the curved portion 113C or, as an example, may correspond to a partial area of the curved portion 113C. The curved portion 113C may be an area with low external light reflection visibility because there are many portions where external light is mixed with reflected light and disappears when the external light is incident and reflected. The separation area 115 may be arranged in the area, i.e., the curved portion 113C, thereby reducing or suppressing the occurrence of spots due to uneven external light reflection, which is caused by the separation area 115.

In an example, in case of arranging the plurality of separation areas 115, the curved portion 113C may be arranged in an area opposing each of the plurality of separation areas 115. For example, on the basis of the first extension areas 111 opposing each other or the second extension areas 112 opposing each other, the curved portion 113C may be arranged in an area opposite to one separation area 115, and as an optional embodiment, another separation area 115 may be formed in the corresponding area. This configuration may reduce or suppress the occurrence of spots, which is caused by uneven external light reflection interruption due to the separation area 115 when external light is reflected in the mesh-shaped touch electrode 110 having the regular structure.

As an example, the display apparatus 100 may be configured such that a plurality of unit areas are repeatedly arranged. For example, a first unit area CTR1, a second unit area CTR2, a third unit area CTR3, and a fourth unit area CTR4 illustrated in FIG. 1 may have the same shape, with a difference only in the position of the separation area 115.

In this instance, the position of the separation area 115 arranged in each unit area may be the same as the position of the separation area 115 in another unit area. As an optional embodiment, in this instance, the position of the separation area 115 arranged in each unit area may correspond to the position of the connection area 113 or the curved portion 113C of another unit area. For example, one separation area 115 of the second unit area CTR2 may correspond to a corresponding connection area 115R where the connection area 113 or the curved portion 113C of the third unit area CTR3 is located.

As an optional embodiment, the position of the separation area 115 arranged in each unit area may correspond to a position between the connection area 113 of another unit area and the first extension area 111 or the position between the connection area 113 and the second extension area 112, for example, to the position where the connection area 113 starts or ends.

With the configuration, on the basis of the entire screen of the display apparatus 200, the separation area 115 may be arranged in an area corresponding to or adjacent to the connection area 113 or curved portion 113C with very little or no external light reflection, thereby reducing or suppressing the occurrence of spots caused by uneven external light reflection interruption due to the separation area 115 when external light is reflected in the mesh-shaped touch electrode 110 having the regular structure.

Referring to FIG. 2, the separation area 115 may be formed corresponding to the connection area 113 and may be formed in a thickness direction of the first extension area 111 or the second extension area 112 such that the width of the separation area 115 may be controlled not to increase.

In some embodiments, when the separation area 115 is formed in the connection area 113, the separation area 115 may be formed in an edge area, other than a middle area, of the curved portion 113C, for example, in an area of the curved portion 113C adjacent to the first extension area 111 or the second extension area 112. Accordingly, the separation area 115 may be located in an area of the curved portion 113C with low or no light reflection, thereby reducing uneven light reflection due to the separation area 115. Also, the width or length of the separation area 115 may be reduced, which may result in improving the electrical characteristics of the touch electrode 110 and enhancing the effect of reducing uneven light reflection.

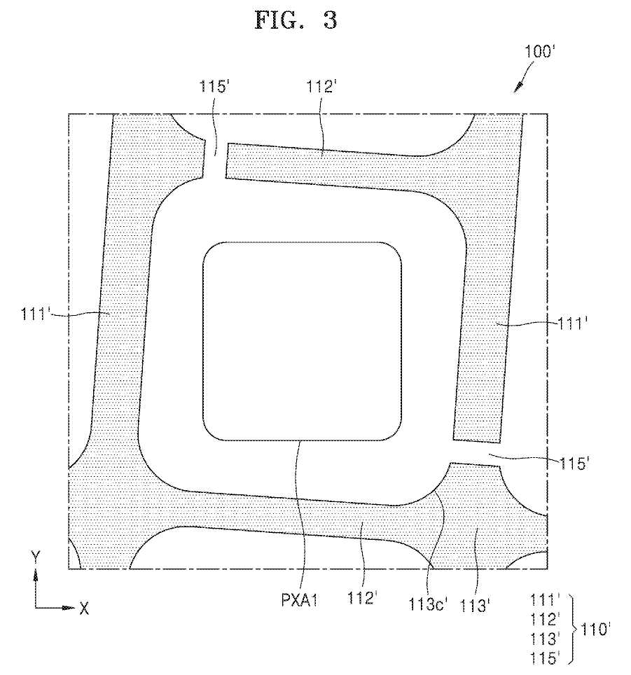

FIG. 3 is a view of a modified example of FIG. 2.

A touch electrode 110' of a display apparatus 100' may be tilted with respect to an emission area PXA1.

For example, the touch electrode 110 of the display apparatus 100 of FIGS. 1 and 2 may have a shape in which the first extension areas 111 and the second extension areas 112 arranged in the mesh structure surround each of the plurality of emission areas PXA1, PXA2, and PXA3 and are aligned overall in a direction parallel to the arrangement direction of the plurality of emission areas PXA1, PXA2, and PXA3, and, as a detailed example, are arranged in parallel in both horizontal and vertical directions.

In other embodiments, the touch electrode 110' of the display apparatus 100' of FIG. 3 may be tilted with respect to the emission area PXA1, and, for example, may be tilted at least 3 degrees, and as a detailed example, at an angle ranging from 3 degrees to 45 degrees. The touch electrode 110' may be tilted with respect to the arrangement direction of the emission area PXA1 that is mainly recognized by the user, which may reduce overall external light reflectivity on the touch electrode 110'. This may reduce or suppress the occurrence of spots due to uneven external light reflection caused by the touch electrode when the display apparatus 100' is used outside or in a place with strong external light, thereby facilitating the display apparatus 100' to be implemented with increased image quality.

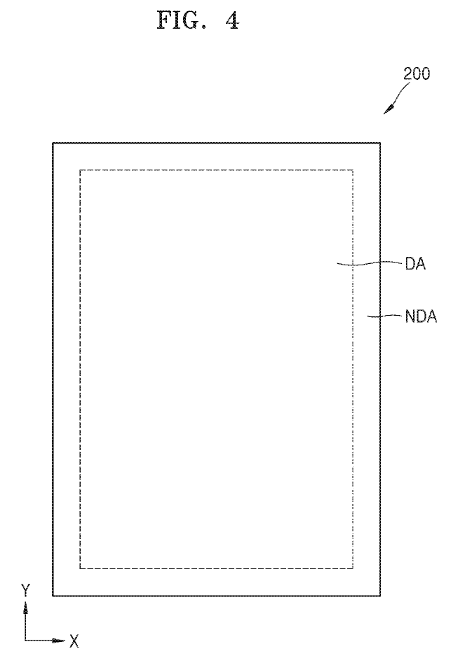

FIG. 4 is a schematic plan view of a display apparatus according to an embodiment.

Referring to FIG. 4, a display apparatus 200 may have various shapes, and may be applied to, for example, polygonal smart phones, and may also be applied to electronic devices, such as televisions, computer monitors, notebook/laptop computers, car navigation units, portable game consoles, audio electronic devices, smart watches, digital cameras, and the like. Those products listed herein are offered only as examples, and the display apparatus may be adopted for other electronic devices without departing from the concept of the disclosure.

Referring to FIG. 4, the display apparatus 200 may include a display area DA and a peripheral area NDA.

The display area DA may include an area where an image is displayed, and for example, a plurality of pixels may be arranged in the display area DA, and each pixel may include a plurality of sub-pixels.

The peripheral area NDA may be formed around the display area DA. The peripheral area NDA may include a non-display area, and as an example, the non-display area may surround the display area DA. As an optional embodiment, the peripheral area NDA or the non-display area of the peripheral area NDA may be formed adjacent to only one side or opposite sides of the display area DA.

As an optional embodiment, a driving circuit area for generating various signals for operation of pixels in the display area DA may be arranged in the peripheral area NDA, and the driving circuit area may have one or more driving circuits.

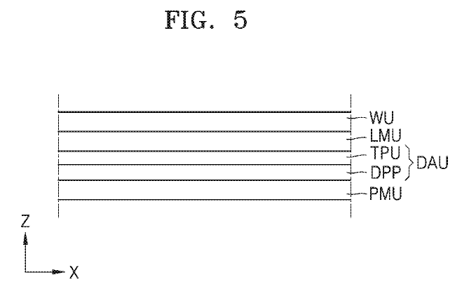

FIG. 5 is a schematic cross-sectional view of the display apparatus of FIG. 4.

Referring to FIG. 5, the display apparatus 200 may include a display module DAU, an optical device LMU, and a window WU. As used herein, the optical device may be a lens or mirror or another similar device configured to change the manner in which light propogates.

The window WU may oppose one side (e.g., a front or rear side) of the display module DAU.

The optical device LMU may be arranged between the display module DAU and the window WU.

As an optional embodiment, a protective device PMU may correspond to an opposite surface to a surface, which opposes the window Wu, among surfaces of the display module DAU, for example, the protective device PMU may include a film shape.

As an optional embodiment, an adhesive layer may be arranged between the display module DAU and the optical device LMU, and may also be arranged between the optical device LMU and the window WU. The adhesive layer may include one of a variety of types, and may include, for example, an organic adhesive layer, such as, an optically clear adhesive (OCA) film, an optically clear resin (OCR), or a pressure sensitive adhesive (PSA) film.

The protective device PMU may protect the display module DAU. The protective device PMU may reduce or suppress external moisture from penetrating the display module DAU and may absorb external impact.

For example, the protective device PMU may include a plastic film as a base layer. As a specific example, the protective device PMU may include a plastic film which may include any one selected from a group consisting of polyethersulfone (PES), polyacrylate, polyetherimide (PEI), polyethylenenaphthalate (PEN), polyethyleneterephthalate (PET), polyphenylene sulfide (PPS), polyarylate, polyimide (PI), polycarbonate (PC), polyarylene ethersulfone, and combinations thereof.

The material included in the protective device PMU is not necessarily limited to plastic resins, but may include organic/inorganic composite materials, and may also include a porous organic layer and an inorganic substance filled in the pores of the organic layer. The protective device PMU may further include a functional layer formed on a plastic film. The functional layer may include a resin layer. The functional layer may be formed by a coating method. The protective device PMU may be omitted if required.

The window WU may protect the display module DAU from external impact and may also provide an input surface to the user.

The window WU may include a variety of materials, for example, glass, organic substances, and plastic-based materials. As an example, the window WU may include a plastic film.

As an optional embodiment, the window WU may have a multi-layer structure.

As an example, the window WU may have a multi-layer structure selected from a glass substrate, a plastic film, or a plastic substrate.

As an example, the window WU may further include a bezel pattern.

The optical device LMU may reduce external light reflectivity. The optical device LMU may include at least a polarizing film. The optical device LMU may further include a phase difference film. In some embodiments, the technical idea of the disclosure is not necessarily limited thereto, and the optical device LMU may be omitted.

The display module DAU may include a display panel DPP and a touch sensing unit TPU. In some cases, the display apparatus 200 may include the display module DAU.

The touch sensing unit TPU may be arranged on the display panel DPP.

As an optional embodiment, the touch sensing unit TPU may be directly arranged on the display panel DPP. The phrase “directly arranged” as used herein may exclude attachment using a separate adhesive layer and may refer to being formed by a continuous process.

The display panel DPP may generate an image corresponding to input image data, and may be various types of panels. For example, the display panel DPP may include an organic light-emitting display panel. As an example, the display panel DPP may include a liquid crystal display panel, a quantum dot display panel, an inorganic light-emitting display panel, and other various types of display panels.

The touch sensing unit TPU may acquire coordinate information of an external input. The touch sensing unit TPU may sense an external input in an electrostatic capacitive manner.

The display module DAU, according to an embodiment, may further include an anti-reflection layer. The anti-reflection layer may include a color filter or a laminate structure of a conductive layer, an insulating layer, and a conductive layer. The anti-reflection layer may reduce external light reflectivity by absorbing, destructively interfering, or polarizing light incident from the outside. The anti-reflection layer may also replace the function of the optical device LMU.

The display apparatus 200 may further include a frame structure which supports one state at least a moment when the display apparatus 200 is in a specific state, for example, a flat, bent, or folded state, and the frame structure may include a joint structure or a hinge structure.

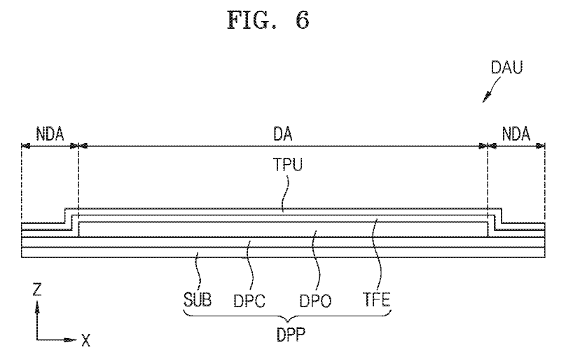

FIG. 6 is a schematic cross-sectional view of the display module of the display apparatus of FIG. 4.

Referring to FIG. 6, the display module DAU may include the display panel DPP and the touch sensing unit TPU.

The display panel DPP may include a base substrate SUB, a circuit layer DPC arranged on the base substrate SUB, a display layer DPO, and an encapsulation portion TFE.

The base substrate SUB may include various materials. In some embodiments, the base substrate SUB may include glass, metal, organic substances, or other materials.

As an optional embodiment, the base substrate SUB may be formed of a flexible material. For example, the base substrate SUB may be flexible, bendable, foldable, or rollable, to at least a noticeable extent without cracking or otherwise sustaining damage.

As an optional embodiment, the base substrate SUB may include ultra-thin glass, metal, or plastic. For example, in case of using plastic, the base substrate SUB may contain polyimide (PI), and as another detailed example, the base substrate SUB may contain at least one of polystyrene, polyvinyl alcohol, polymethyl methacrylate, polyethersulfone, polyacrylate, polyetherimide, polyethylene naphthalate, polyethylene terephthalate, polyphenylene sulfide, polyarylate, polycarbonate, triacetate cellulose, or cellulose acetate propionate.

The base substrate SUB may also have a structure of one or more layers, for example, a plurality of layers. For example, the base substrate SUB may include an organic layer (e.g., a resin-based material) and an inorganic layer, and as a more detailed example, may include a structure in which an inorganic layer is arranged between two organic layers.

The circuit layer DPC may include a plurality of insulating layers, a plurality of conductive layers, and a semiconductor layer. The plurality of conductive layers of the circuit layer DPC may configure control circuits of signal lines or pixels. The display layer DPO may include display which implement one or more types of light, and may include, for example, organic light-emitting diodes. The encapsulation portion TFE may protect the display layer DPO, for example, to seal the display layer DPO.

As a detailed example, the encapsulation portion TFE may include an inorganic layer or an organic layer. As an optional embodiment, the encapsulation portion TFE may include a laminate structure of an inorganic layer and an organic layer, for example, may include at least two inorganic layers and an organic layer arranged between the two inorganic layers. The inorganic layer of the encapsulation portion TFE may protect the display layer DPO from moisture/oxygen, and the organic layer may protect the display layer DPO from foreign substances, such as dust particles.

The inorganic layer of the encapsulation portion TFE may include a silicon nitride layer, a silicon oxynitride layer and a silicon oxide layer, a titanium oxide layer, or an aluminum oxide layer. The organic layer of the encapsulation portion TFE may include, but is not necessarily limited to, an acrylic-based organic layer.

As described above, the touch sensing unit TPU may be arranged on the encapsulation portion TFE, or as an optional embodiment, may be directly arranged. The touch sensing unit TPU may include touch sensors and touch signal lines. The touch sensors and touch signal lines may have a single-layer structure or a multi-layer structure. The touch sensors and touch signal lines may include indium tin oxide (ITO), indium zinc oxide (ZnO), zinc oxide (ZnO), indium tin zinc oxide (ITZO), PEDOT, a metal nano wire, and a graphene. The touch sensors and touch signal lines may include a metal layer, for example, molybdenum, silver, titanium, copper, aluminum, or an alloy thereof. The touch sensors and touch signal lines may have the same layer structure or different layer structures. The touch sensing unit TPU will be described in detail later.

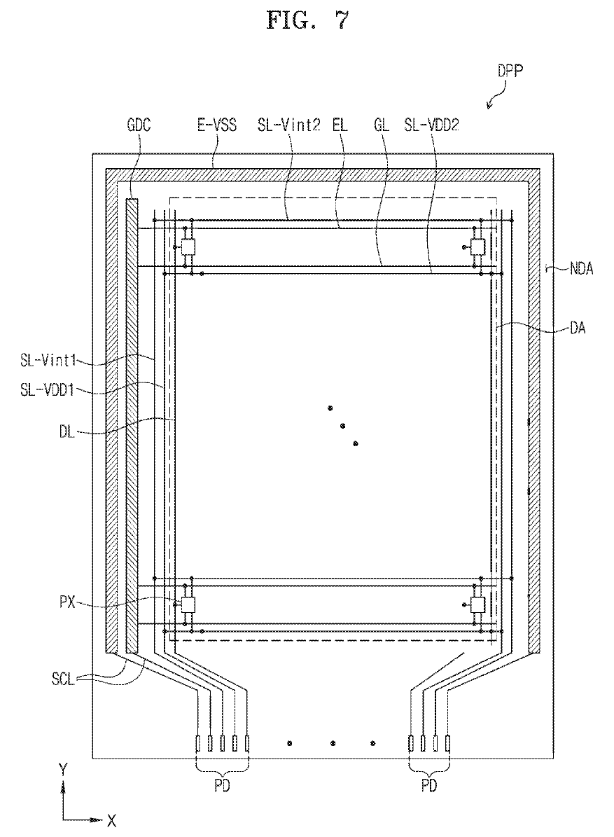

FIG. 7 is a schematic plan view of the display panel of the display apparatus of FIG. 4.

Referring to FIG. 7, the display panel DPP may include a display area DA and a peripheral area NDA proximate to the display area DA, on a common plane. The display area DA and the peripheral area NDA of the display panel DPP may correspond to the display area DA and the peripheral area NDA of the display apparatus 200, respectively.

As an example, the display area DA and the peripheral area NDA of the display panel DPP might not be required to be identical to the display area DA and the peripheral area NDA of the display apparatus 200, and may vary depending on the structure/design of the display panel DPP.

The display panel DPP may include a plurality of gate lines GL, a plurality of data lines DL, a plurality of light-emitting lines EL, a plurality of first and second initialization lines SL-Vint1 and SL-Vint2, a plurality of first power lines SL-VDD1 and SL-VDD2, a second power line E-VSS, a plurality of pad parts PD, a plurality of signal connection lines SCL, a gate-light emission driving part GDC, and a plurality of pixels PX.

The pixels PX may be arranged in the display area DA. Each of the gate lines GL may extend in a first direction (e.g., in an X-axis direction) and be connected to a corresponding pixel PX of the plurality of pixels PX, and each of the data lines DL may extend in a second direction (e.g., in a Y-axis direction) and be connected to a corresponding pixel PX of the plurality of pixels PX. Each of the light-emitting lines EL may extend in the first direction and be connected to a corresponding pixel PX of the plurality of pixels PX.

The first power lines SL-VDD1 and SL-VDD2 may include a plurality of first sub-power lines SL-VDD1 extending in the second direction (the Y-axis direction) and a plurality of second sub-power lines SL-VDD2 extending in the first direction (the X-axis direction) and connected to the first sub-power lines SL-VDD1. The second sub-power lines SL-VDD2 may be connected to the pixels PX, and the first and second sub-power lines SL-VDD1 and SL-VDD2 may receive a first voltage. The first voltage may be defined as an anode voltage.

The first initialization lines SL-Vint1 may extend in the second direction (e.g., the Y-axis direction), and the second initialization lines SL-Vint2 may extend in the first direction (e.g., the X-axis direction) and be connected to the first initialization lines SL-Vint1. The first initialization lines SL-Vint1 may be connected to the pixels PX and receive an initialization voltage.

The gate-light emission driving part GDC may be arranged on one side of the peripheral area NDA and may be connected to the gate lines GL and the light-emitting lines EL. The gate-light emission driving part GDC may receive a control signal through a corresponding first signal connection line among the signal connection lines SCL, and generate gate signals and emission signals in response to the received control signal. One end of the first signal connection line may be connected to the gate-light emission driving part GDC, and another end of the first signal connection line may be connected to the pad parts PD.

The gate lines GL may receive the gate signals, and the light-emitting lines EL may receive the emission signals. Another gate-light emitting driving part may further oppose the gate-light emission driving part GDC.

The second power line E-VSS may receive a second voltage, and the second voltage may be defined as a cathode voltage (or a ground voltage). The second voltage may be applied to the pixels PX through the second power line E-VSS. The second power line E-VSS may receive a control signal through a corresponding second signal connection line among the signal connection lines SCL. One end of the second signal connection line may be connected to the second power line E-VSS, and another end of the second signal connection line may be connected to the pad parts PD.

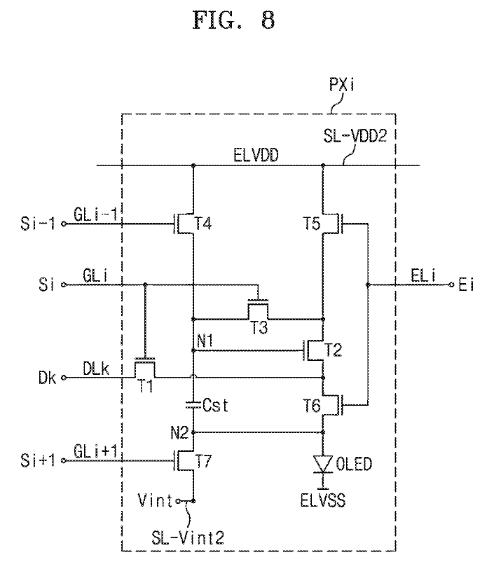

FIG. 8 is a schematic view of an equivalent circuit view of the pixel of the display apparatus of FIG. 4.

In FIG. 8, an i^{th} pixel PXi connected to a k^{th} data line DLk among the data lines DL is illustrated as an example. Referring to FIG. 8, the i^{th} pixel PXi may include an organic light-emitting diode OLED and a pixel driving circuit which controls the organic light-emitting diode OLED. The driving circuit may include seven thin film transistors T1 to T7 and one storage capacitor Cst. Here, i and k may be positive integers.

In some embodiments, FIG. 8 illustrates a pixel driving circuit including seven thin film transistors T1 to T7 and one storage capacitor Cst, but the driving circuit, according to this embodiment, may be modified in various ways. Also, the pixel PXi may include, as the driving circuit for driving the organic light-emitting diode OLED, a first transistor T1 (or driving transistor), a second transistor T2 (or switching transistor), and a storage capacitor Cst, and other transistors and capacitors may be selectively applied.

The first transistor (the driving transistor) T1 may control a driving current supplied to the organic light-emitting diode OLED. An output electrode of the second transistor (the switching transistor) T2 may be electrically connected to the organic light-emitting diode OLED. The output electrode of the second transistor T2 may be in direct contact with an anode of the organic light-emitting diode OLED or may be connected to the anode via another transistor, for example, a sixth transistor T6.

A control electrode of a control transistor may receive a control signal. Control signals applied to the i^{th} pixel PXi may include an i-1^{th} gate signal Si-1, an i^{th} gate signal Si, an i+1^{th} gate signal Si+1, a data signal Di, and an i^{th} emission control signal Ei. In an embodiment, control transistors may include a first transistor T1 and third to seventh transistors T3 to T7.

The first transistor T1 may include an input electrode connected to a k^{th} data line DLk, a control electrode connected to an i^{th} gate line SLi, and an output electrode connected to the output electrode of the second transistor T2. The first transistor T1 may be turned on by a gate signal Si (hereinafter, referred to as an i^{th} gate signal) applied to the i^{th} gate line SLi and may apply a data signal Dk applied to the k^{th} data line DLk to the storage capacitor Cst.

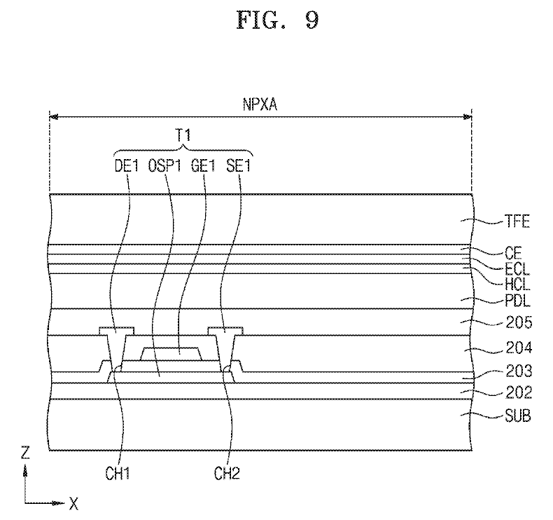

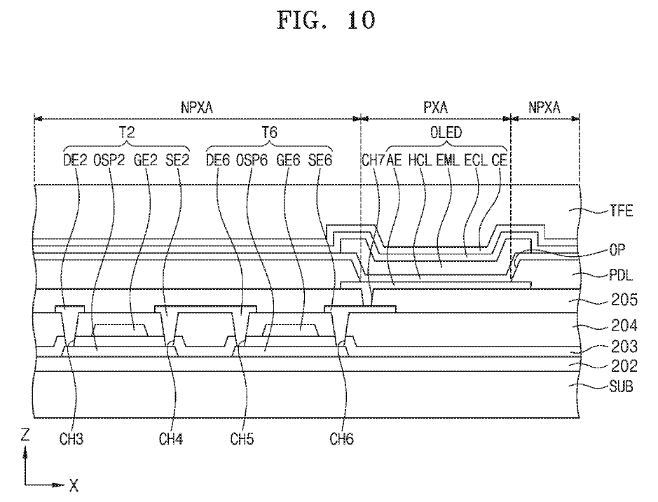

FIGS. 9 and 10 are schematic cross-sectional views of the display panel of the display apparatus of FIG. 4. For example, FIG. 9 may be a cross-sectional view illustrating a non-emission area NPXA, and FIG. 10 may be a cross-sectional view illustrating an emission area PXA.

Referring to FIGS. 9 and 10, the first transistor T1, the second transistor T2, and the sixth transistor T6 may be arranged on the base substrate SUB. The structures of the transistors may be substantially the same. Therefore, for convenience of explanation, the following description will focus on the configuration of the first transistor T1, and the descriptions of the configurations of the second and sixth transistors T2 and T6 will be assumed to be substantially the same as was previously described.

The first transistor T1 may include a first input electrode DE1, a first output electrode SE1, a first control electrode GE1, and a first semiconductor pattern OSP1.

A buffer layer 202 may be arranged on an upper surface of the base substrate SUB.

The buffer layer 202 may be arranged on the base substrate SUB. The buffer layer 202 may reduce or suppress the introduction or diffusion of impurities through the base substrate SUB.

The buffer layer 202 may contain various materials, for example, may contain inorganic materials. As a detailed example, the buffer layer 202 may contain silicone-based materials. As an optional embodiment, the buffer layer 202 may include at least one of silicon nitride (SiNx), silicon oxide (SiOx), or silicon oxynitride (SiOxNy).

As an example, the buffer layer 202 may contain an oxide, and as a detailed example, may include at least one of metal oxides, such as aluminum oxide (AlOx).

As an optional embodiment, the buffer layer 202 may include a plurality of layers, including at least two layers.

The first semiconductor pattern OSP1 may be arranged on the buffer layer 202.

The first semiconductor pattern OSP1 may contain a semiconductor material, for example, a silicon-based semiconductor material, and as a detailed example, a polysilicon-based material. As an example, the first semiconductor pattern OSP1 may include an oxide semiconductor, for example, indium tin oxide (ITO), indium gallium zinc oxide (IGZO), zinc oxide (ZnO), indium zinc oxide (IZnO), or the like.

A first insulating layer 203 covering the first semiconductor pattern OSP1 may be arranged on the buffer layer 202.

A first control electrode GE1 may be arranged on the first insulating layer 203, and a second insulating layer 204 covering the first control electrode GE1 may be arranged on the first insulating layer 203. The second insulating layer 204 may provide a flat upper surface. The second insulating layer 204 may include an organic material and/or an inorganic material.

As an example, the first insulating layer 203 or the second insulating layer 204 may include an inorganic material. The inorganic material may include at least one of aluminum oxide, titanium oxide, silicon oxide, silicon oxynitride, zirconium oxide, or hafnium oxide.

In some embodiments, a first contact hole CH1 and a second contact hole CH2 exposing a first region and a second region of the first semiconductor pattern OSP1 may be defined in the first and second insulating layers 203 and 204. Each of the first contact hole CH1 and the second contact hole CH2 may be formed through the first insulating layer 203 and the second insulating layer 204.

The first input electrode DE1 and the first output electrode SE1 may be arranged on the second insulating layer 204. The first input electrode DE1 and the first output electrode SE1 may be respectively connected to the first region and the second region of the first semiconductor pattern OSP1 through the first contact hole CH1 and the second contact hole CH2.

A third insulating layer 205 covering the first input electrode DE1 and the first output electrode SE1 may be arranged on the second insulating layer 204. The third insulating layer 205 may provide a flat upper surface. The third insulating layer 205 may include an organic material and/or an inorganic material.

FIG. 10 illustrates an example of the sixth transistor T6 having substantially the same structure as the second transistor T2.

However, the structure of the sixth transistor T6 may be modified. An input electrode DE6 of the sixth transistor T6 may be connected to an output electrode SE2 of the second transistor T2 on the third insulating layer 205.

A pixel defining layer PDL and an organic light-emitting diode OLED may be arranged on the third insulating layer 205. An anode AE may be arranged on the third insulating layer 205. The anode AE may be connected to a sixth output electrode SE6 of the sixth transistor T6 through a seventh contact hole CH7 which is formed through the third insulating layer 205. An opening OP may be defined in the pixel defining layer PDL. The opening OP in the pixel defining layer PDL may expose at least a portion of the anode AE.

The pixel PX may be arranged in a pixel area on a plane of an organic light-emitting display panel DP. The pixel area may include an emission area PXA and a non-emission area NPXA adjacent to the emission area PXA. The non-emission area NPXA may surround the emission area PXA on at least one side thereof.

The emission area PXA may correspond to the anode AE, or in an example, the emission area PXA may be defined as an area where light is emitted. For example, the emission area PXA may be defined to correspond to a partial area of the anode AE exposed by the opening OP of the pixel defining layer PDL.

As an optional embodiment, a hole control layer HCL may be commonly arranged in the emission area PXA and the non-emission area NPXA. A common layer, such as the hole control layer HCL, may be formed in common over the plurality of pixels PX.

An organic light-emitting layer EML may be arranged on the hole control layer HCL. The organic light-emitting layer EML may correspond to the opening OP. For example, the organic light-emitting layer EML may be formed separately in each of the plurality of pixels PX.

As an optional embodiment, an electron control layer ECL may be arranged on the organic light-emitting layer EML. A cathode CE may be arranged on the electron control layer ECL.

The cathode CE may be arranged in common over the plurality of pixels PX.

The encapsulation portion TFE may be arranged on the cathode CE, as described with reference to FIG. 6.

Although the patterned organic light-emitting layer EML is illustrated as an example in this embodiment, the organic light-emitting layer EML may be arranged in common over the plurality of pixels PX. In some embodiments, the organic light-emitting layer EML may generate white light. The organic light-emitting layer EML may have a multi-layer structure.

As an optional embodiment, one or more functional layers may further be arranged between the encapsulation portion TFE and the cathode CE, for example, a capping layer covering the cathode CE may be further arranged.

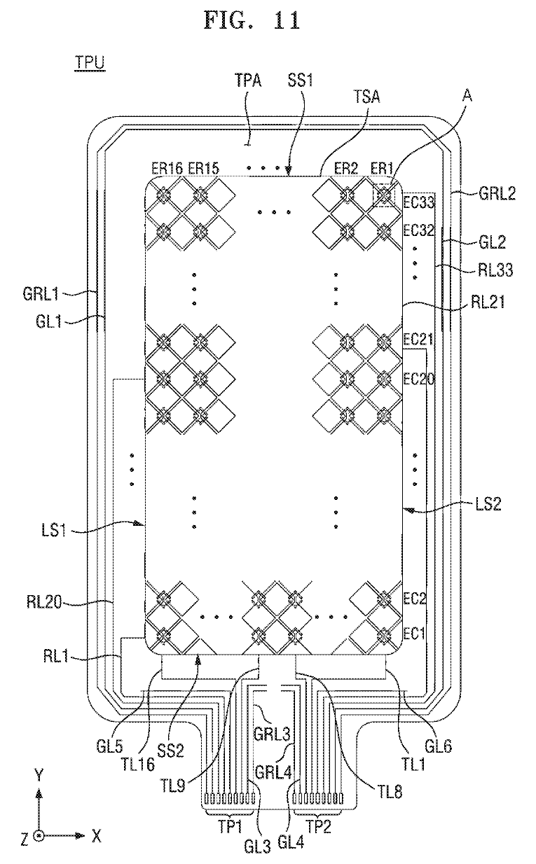

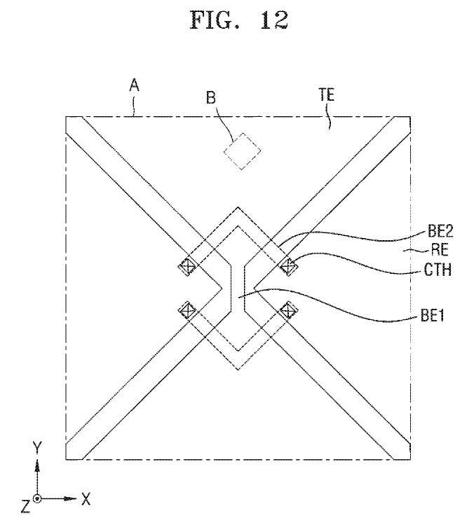

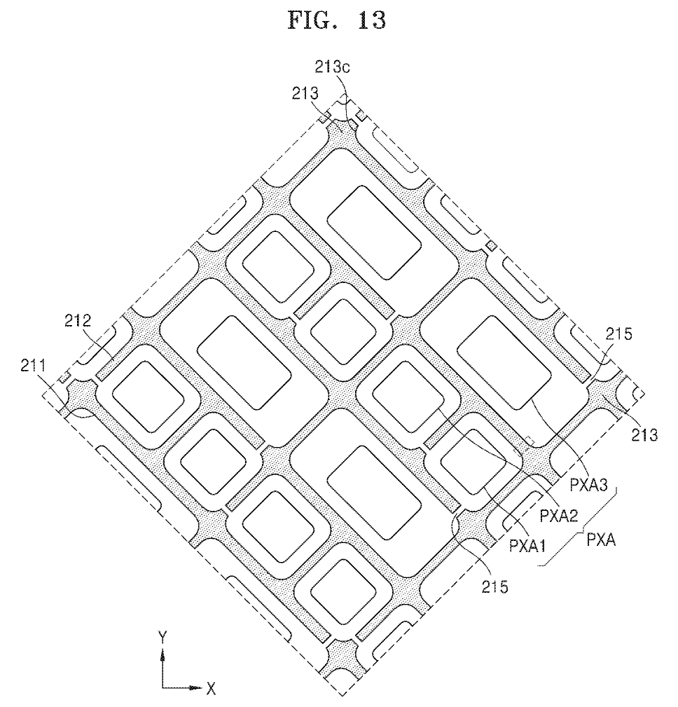

FIG. 11 is a schematic plan view of a touch sensing unit of the display apparatus of FIG. 4. FIG. 12 is a schematic enlarged view of an area A of FIG. 11. FIG. 13 is a schematic enlarged view of an area B of FIG. 12.

For convenience of explanation, first touch electrodes TE, second touch electrodes RE, first touch lines TL1 to TL16, second touch lines RL1 to RL33, a first touch pad part TP1, and a second touch pad part TP2 are illustrated.

Hereinafter, for convenience of explanation, the first touch lines will be described as driving lines TL1 to TL16, and the second touch lines will be described as sensing lines RL1 to RL33.

Referring to FIG. 11, the touch sensing unit TPU may include a touch sensor area TSA for sensing a user's touch and a touch peripheral area TPA arranged around the touch sensor area TSA. The touch sensor area TSA may overlap the display area DA of the display panel DPP, and the touch peripheral area TPA may overlap the peripheral area NDA of the display panel DPP.

The touch sensor area TSA may include a first short side SS1 and a second short side SS2 extending in the first direction (the X-axis direction) and opposing each other in the second direction (the Y-axis direction), and may also include a first long side LS1 and a second long side LS2 extending in the second direction (the Y-axis direction) crossing the first direction (the X-axis direction) and opposing each other in the first direction (the X-axis direction). Corners where the first long side LS1 and the second long side LS2 meet the first short side SS1 and the second short side SS2 may be rounded with a constant curvature. However, the configuration is not necessarily limited thereto, and in some embodiments, the corners where the first long side LS1 and the second long side LS2 meet the first short side SS1 and the second short side SS2 may be cut.

The first short side SS1, the second short side SS2, the first long side LS1, and the second long side LS2 may correspond to respective edges of the display panel DPP, for example, may overlap the respective edges of the display panel DPP and have substantially the same lengths as the respective edges of the display panel DPP. However, the configuration is not necessarily limited thereto, and the first short side SS1, the second short side SS2, the first long side LS1, and the second long side LS2 constituting the touch sensor area TSA may be formed differently from the respective edges of the display area DA depending on an area where a touch function is to be implemented in the display apparatus 200.

Touch electrodes TE and RE may be arranged in the touch sensor area TSA. The touch electrodes TE and RE may include first touch electrodes TE and second touch electrodes RE. The first touch electrodes TE may be driving electrodes and the second touch electrodes RE may be sensing electrodes, or vice versa. Hereinafter, an example will be described in which the first touch electrodes TE are driving electrodes and the second touch electrodes RE are sensing electrodes.

As an example, sixteen first touch electrodes TE may be arranged in the first direction (the X-axis direction) and thirty-three second touch electrodes RE may be arranged in the second direction (the Y-axis direction) in the touch sensor area TSA. For example, the touch electrodes TE and RE may be arranged in thirty-three columns EC1 to EC33 and sixteen rows ER1 to ER16. The first touch electrodes TE may be arranged in the sixteen rows ER1 to ER16, and the second touch electrodes RE may be arranged in the thirty-three columns EC1 to EC33. However, this is an example for convenience of explanation and is not necessarily limited thereto. The number and arrangement of the touch electrodes TE and RE arranged in the touch sensor area TSA are not necessarily limited thereto.

For example, the touch electrodes TE and RE may have a diamond shape, but are not necessarily limited thereto, and the shape of the touch electrodes TE and RE may change into various shapes, such as a triangle, square, pentagon, circle, bar, and the like.

The first touch electrodes TE and the second touch electrodes RE are illustrated as having the same shape, but are not necessarily limited thereto. The first touch electrodes TE and the second touch electrodes RE may have different shapes, and the first touch electrodes TE and the second touch electrodes RE may also have different areas and thicknesses.

In some embodiments, observing the touch electrodes TE and RE more precisely, the touch electrodes TE and RE may have a mesh structure with a plurality of openings. In some embodiments, the first touch electrodes TE and the second touch electrodes RE may include a mesh structure in which the first and second touch electrodes TE and RE are formed of the same material and adjacent to each other on the same plane, and may be separated from each other, for example, through cut areas. The corresponding cut area may have a diagonal line, or as an example, may include an area having a plurality of curves.

As illustrated in FIG. 12, the first touch electrodes TE may be electrically connected in the second direction (the Y-axis direction) through first connection electrodes BE1, and the second touch electrodes RE may be electrically connected in the first direction (the X-axis direction) crossing the second direction (the Y-axis direction) through second connection electrodes BE2.

In the case of the touch sensing unit TPU having a major axis and a minor axis, the deviation in sensitivity in the major axis direction may be greater than the deviation in sensitivity in the minor axis direction, and touch sensitivity on the entire touch sensing unit TPU may be reduced depending on the deviation in sensitivity in the major axis direction. In this embodiment, the second connection electrodes BE2 may connect the second touch electrodes RE, which are arranged in the minor axis direction, in the first direction (the X-axis direction), thereby reducing resistance of the first touch electrodes TE arranged in the major axis direction. This may effectively reduce the deviation in sensitivity of the first touch electrodes TE arranged in the major axis direction. Accordingly, the touch sensitivity on the entire touch sensing unit TCU may be increased.

To suppress the first touch electrodes TE and the second touch electrodes RE from being short-circuited with each other at intersection areas, the first connection electrodes BE1 and the second connection electrodes BE2 may be arranged on different layers. For example, the first touch electrodes TE, the second touch electrodes RE, and the first connection electrodes BE1 may be arranged on the same plane, and the second connection electrodes BE2 may be formed on a different layer, for example, a lower layer, to be in contact with the second touch electrodes RE adjacent to each other through contact areas CTH, respectively, such that the electrical connection of the second touch electrodes RE may be enabled.

The driving lines TL1 to TL16 and the sensing lines RL1 to RL33 may be arranged in the touch peripheral area TPA. The driving lines TL1 to TL16 may be electrically connected to the first touch electrodes TE, respectively, and the sensing lines RL1 to RL33 may be electrically connected to the second touch electrodes RE, respectively. In some examples, the first touch electrodes TE may be electrically connected in the second direction (the Y-axis direction). Accordingly, the driving lines TL1 to TL16 may be connected to the first touch electrodes TE, which are arranged at an end of one side in the touch sensor area TSA, of the first touch electrodes TE electrically connected in the second direction (the Y-axis direction).

For example, as illustrated in FIG. 11, the first to sixteenth driving lines TL1 to TL16 may be connected on a one-to-one basis to the first touch electrodes TE in the first to sixteenth rows ER1 to ER16 arranged at an end of a lower side in the touch sensor area TSA. The first driving line TL1 may be connected to the first touch electrode TE, which is adjacent to the lowest side based on FIG. 11, in the first row ER1 located at the rightmost side of the touch sensor area TSA. The sixteenth driving line TL16 may be connected to the first touch electrode TE, which is adjacent to the lowest side based on FIG. 11, in the sixteenth row ER16 located at the leftmost side of the touch sensor area TSA.

In FIG. 11, for convenience of explanation, an example is illustrated in which the first row ER1 is the rightmost row of the touch sensor area TSA, the sixteenth row ER16 is the leftmost row of the touch sensor area TSA, and the second to fifteenth rows ER2 to ER15 are sequentially arranged between the first row ER1 and the sixteenth row ER16.

The second touch electrodes RE may be electrically connected in the first direction (the X-axis direction). Accordingly, the sensing lines RL1 to RL33 may be connected to the second touch electrodes RE, which are arranged at an end of one or another side in the touch sensor area TSA, among the second touch electrodes RE electrically connected in the first direction (the X-axis direction). The sensing lines RL1 to RL33 may be distributively arranged at left and right sides of the touch sensor area TSA.

For example, as illustrated in FIG. 11, the first to twentieth sensing lines RL1 to RL20 may be arranged at the left side of the touch sensor area TSA. The first to twentieth sensing lines RL1 to RL20 may be connected on a one-to-one basis to the second touch electrodes RE in the first to twentieth columns EC1 to EC20 arranged at the left side of the touch sensor area TSA. The first sensing line RL1 may be connected to the second touch electrode RE which is adjacent to the leftmost side based on FIG. 11 in the first column EC1 located at the lowest side of the touch sensor area TSA. The twentieth sensing line RL20 may be connected to the second touch electrode RE which is adjacent to the leftmost side based on FIG. 11 in the twentieth column EC20 of the touch sensor area TSA.

For convenience of explanation, FIG. 11 illustrates that the first column EC1 is the lowest column in the touch sensor area TSA, and the second to twentieth columns EC2 to EC20 are sequentially arranged in an upward direction (the Y-axis direction) from the first column EC1.

The twenty-first to thirty-third sensing lines RL21 to RL33 may be arranged at the right side of the touch sensor area TSA. The twenty-first to thirty-third sensing lines RL21 to RL33 may be connected on a one-to-one basis to the second touch electrodes RE in the twenty-first to thirty-third columns EC21 to EC33 arranged at the right side of the touch sensor area TSA. The twenty-first sensing line RL21 may be connected to the second touch electrodes RE, which are adjacent to the rightmost side based on FIG. 11, in the twenty-first column EC21 of the touch sensor area TSA. The thirty-third sensing line RL33 may be connected to the second touch electrodes RE, which are adjacent to the rightmost side based on FIG. 11, in the thirty-third column EC33 of the touch sensor area TSA.

FIG. 11 illustrates an example in which the twenty-second to thirty-second columns EC22 to EC32 are sequentially arranged in the upward direction (the Y-axis direction) from the twenty-second column EC22.

In some embodiments, for convenience of explanation, the first to twentieth sensing lines RL1 to RL20 may be defined as sensing lines of a first group or second touch lines of a first group, and the twenty-first to thirty-third sensing lines RL21 to RL33 may be defined as sensing lines of a second group or second touch lines of a second group.

In this instance, the sensing lines RL1 to RL20 of the first group may be arranged at the left side of the touch sensor area TSA, and the sensing lines RL21 to RL33 of the second group may be arranged at the right side of the touch sensor area TSA. This structure may have an advantage of improving touch sensitivity by reducing sensitivity deviation, compared to a structure in which the sensing lines RL1 to RL33 are alternately arranged in odd and even columns.

The sensing lines of the first group may be twenty sensing lines, while the sensing lines of the second group may be thirteen sensing lines. For example, the number of sensing lines of the first group and the number of sensing lines of the second group may be different from each other. Lengths of the sensing lines of the second group may be longer than lengths of the sensing lines of the first group. Therefore, when widths of the sensing lines of the second group are wider than widths of the sensing lines of the first group, there may be an advantage in that resistance deviation between the sensing lines of the first group and the sensing lines of the second group may be minimized.

However, such grouping may be carried out in various ways, and might not be performed depending on the size and shape of the display apparatus 200.

A first guard line GL1 may be located between a first ground line GRL1 and the twentieth sensing line RL20, and may surround a portion of the lower side, the left side, and a portion of the upper side of the touch sensor area TSA. A second guard line GL2 may be located between a second ground line GRL2 and the thirty-third sensing line RL33, and may surround a portion of the lower side, the right side, and a portion of the upper side of the touch sensor area TSA. One end of the first guard line GL1 and one end of the second guard line GL2 may oppose each other on the upper side of the touch sensor area TSA and may be spaced apart from each other in the first direction (the X-axis direction).

A third guard line GL3 may be located between a third ground line GRL3 and the ninth driving line TL9, and may oppose a portion of the lower side of the touch sensor area TSA. A fourth guard line GL4 may be located between a fourth ground line GRL4 and the eighth driving line TL8, and may oppose a portion of the lower side of the touch sensor area TSA.

A fifth guard line GL5 may be located between the first sensing line RL1 and the sixteenth driving line TL16, and a sixth guard line GL6 may be located between the twenty-first sensing line RL21 and the first driving line TL1.

The first ground line GRL1 may be arranged on the left of the first guard line GL1, and may surround the first guard line GL1. The second ground line GRL2 may be arranged on the right of the second guard line GL2, and may surround the second guard line GL2.

The third ground line GRL3 may be connected to a first touch pad located at the rightmost side of a first touch pad part TP1. The fourth ground line GRL4 may be connected to a second touch pad located at the leftmost side of a second touch pad part TP2.

The first ground line GRL1 and the second ground line GRL2 may be arranged at the outermost sides of the left, upper, and right sides of the touch sensing unit TPU. The third ground line GRL3 and the fourth ground line GRL4 may be arranged at the lower side of the touch sensing unit TPU. Accordingly, the touch sensor area TSA, the driving lines TL1 to TL16, and the sensing lines RL1 to RL33 may be surrounded by the first ground line GRL1, the second ground line GRL2, the third ground line GRL3, and the fourth ground line GRL4. Therefore, when static electricity is applied from the outside, the static electricity may be discharged to the first ground line GRL1, the second ground line GRL2, the third ground line GRL3, and the fourth ground line GRL4. For example, the touch sensor area TSA, the driving lines TL1 to TL16, and the sensing lines RL1 to RL33 may be protected from the static electricity.

The first guard line GL1 may serve to minimize the affection of the voltage change of the first ground line GRL1 to the first to twentieth sensing lines RL1 to RL20. The second guard line GL2 may serve to minimize the affection of the voltage change of the second ground line GRL2 to the twenty-first to thirty-third sensing lines RL21 to RL33.

The third guard line GL3 may serve to minimize the affection of the voltage change of the third ground line GRL3 to the ninth to sixteenth driving lines TL9 to TL16. The fourth guard line GL4 may serve to minimize the affection of the voltage change of the fourth ground line GRL4 to the first to eighth driving lines TL1 to TL8. The fifth guard line GL5 may serve to minimize the affection of the first sensing line RL1 and the sixteenth driving line TL1 to each other. The sixth guard line GL6 may serve to minimize the affection of the twenty-first sensing line RL21 and the first driving line TL1 to each other.

To this end, when the first touch electrodes TE and the second touch electrodes RE are driven using mutual capacitance, a ground voltage may be applied to the first guard line GL1, the second guard line GL2, the third guard line GL3, the fourth guard line GL4, the fifth guard line GL5, and the sixth guard line GL6. When the first touch electrodes TE and the second touch electrodes RE are driven using self-capacitance, driving signals, which are the same as driving signals applied to the driving lines TL1 to TL16 and the sensing lines RL1 to RL33, may be applied to the first guard line GL1, the second guard line GL2, the third guard line GL3, the fourth guard line GL4, the fifth guard line GL5, and the sixth guard line GL6.

The ninth to sixteenth driving lines TL9 to TL16, the first to twentieth sensing lines RL1 to RL20, the first guard line GL1, the third guard line GL3, the fifth guard line GL5, the first ground line GRL1, and the third ground line GRL3 may be connected to the first touch pad part TP1. The first to eighth driving lines TL1 to TL8, the twenty-first to thirty-third sensing lines RL21 to RL33, the second guard line GL2, the fourth guard line GL4, the sixth guard line GL6, the second ground line GRL2, and the fourth ground line GRL4 may be connected to the second touch pad part TP2.

The ninth to sixteenth driving lines TL9 to TL16 may be arranged on the first touch pad part TP1 and the first to eighth driving lines TL1 to TL8 may be arranged on the second touch pad part TP2, thereby increasing the uniformity of the line arrangement and providing an area for arranging the pad parts for the display panel DPP. Also, the first to sixteenth driving lines TL1 to TL16 may have a single routing structure in which the first to sixteenth driving lines TL1 to TL16 are connected only to the first touch electrodes TE of the first to sixteenth rows ER1 to ER16 arranged at the end of the lower side in the touch sensor area TSA, thereby reducing the touch peripheral area TPA.

Explaining the structure in more detail with reference to FIG. 12, the first touch electrodes TE may be spaced apart from one another in the second direction (the Y-axis direction), and the first touch electrodes TE neighboring in the second direction (the Y-axis direction) may be electrically connected through the first connection electrodes BE1. The first connection electrodes BE1 may be arranged at the same layer as the first touch electrodes TE and may be formed together during the process of forming the first touch electrodes TE. The first touch electrodes TE and the first connection electrodes BE1 may be formed integrally with each other.

The second touch electrodes RE may be spaced apart from one another in the first direction (the X-axis direction), and the second touch electrodes RE neighboring in the first direction (the X-axis direction) may be electrically connected through the second connection electrodes BE2. The second connection electrodes BE2 may be arranged at a different layer from the second touch electrodes RE and may come into contact with the second touch electrodes TE through the hole-shaped contact areas CTH. The second connection electrodes BE2 may be bent at least once into a chevron shape like a "<" or ">" on a plane, but the shape of each of the second connection electrodes BE on the plane is not necessarily limited thereto. The second connection electrodes BE2 may overlap some of the first touch electrodes TE and the second touch electrodes RE in a third direction (a Z-axis direction) as a thickness direction. The hole-shaped contact areas CTH may be arranged in areas where the second connection electrodes BE2 and the second touch electrodes RE overlap each other, and the neighboring second touch electrodes RE may come into contact with the neighboring second connection electrodes BE2 through the contact areas CTH, and the second touch electrodes RE neighboring in the first direction (the Z-axis direction) may be electrically connected through the second connection electrodes BE2.

Referring to FIG. 13, an enlarged view of the first touch electrode TE of FIG. 12 is illustrated, which shows the plurality of emission areas PXA1, PXA2, and PXA3 and an area of the mesh-type first touch electrode surrounding the plurality of emission areas PXA1, PXA2, and PXA3. The specific configuration of the first touch electrode TE as described below may be applied even to the second touch electrode RE as it is or substantially the same.

The plurality of emission areas PXA1, PXA2, and PXA3 may be areas where user-recognizable light is emitted, and for example, may each emit light of a different color. In some examples, the first emission area PXA1 may emit red light, the second emission area PXA2 may emit green light, and the third emission area PXA3 may emit blue light.

As an optional embodiment, the plurality of emission areas PXA1, PXA2, and PXA3 may emit light of the same color, for example, blue light.

The first emission area PXA1, the second emission area PXA2, and the third emission area PXA3 may be implemented in a shape similar to a rectangle, which may be implemented by controlling a shape of an emission layer or by utilizing a pattern of an opening of an insulating layer arranged on the emission layer.

As an optional embodiment, the sizes and shapes of the first emission area PXA1, the second emission area PXA2, and the third emission area PXA3 may be controlled in various ways, and for example, as illustrated in FIG. 1, the third emission area PXA3 may be controlled to be larger than the first emission area PXA1 and the second emission area PXA2, so that blue light may be smoothly utilized for implementing an image.

The first touch electrode TE may include a first extension area 211 and a second extension area 212 crossing the first extension area 211.

The first extension area 211 may have a shape that extends in one direction (for example, a direction inclined with respect to the X-axis of FIG. 13, in a detailed example, a direction inclined at 45 degrees with respect to the X-axis), and the second extension area 212 may have a shape that extends in another direction crossing or orthogonal to the one direction.

The first extension area 211, for example, may be arranged in plural to be spaced apart from each other with a gap interposed therebetween. The second extension area 212, for example, may be arranged in plural to be spaced apart from each other with a gap interposed therebetween.

A separation area 215, which is an area where a conductive material of the first touch electrode TE is not formed or cut off, may be formed between the first extension area 211 and a connection area 213, and as an optional embodiment, may include one area of the connection area 213.

As an example, the separation area 215 may be formed between the second extension area 112 and the connection area 213, and as an optional embodiment, may include one area of the connection area 213.

As an example, the separation area 215 may correspond to the connection area 213.

The first touch electrode TE and the second touch electrode RE may be arranged on the same plane, and as a detailed example, may be arranged with an area where the first touch electrode TE and the second touch electrode RE are spaced apart from each other to be distinguished from each other. The user may visibly recognize spots through the spaced area. In the embodiment disclosed herein, the first touch electrode TE may include a plurality of separation areas 215 to reduce or suppress the visible recognition of the spots. A separation area may also be arranged in the second touch electrode RE, similar to the separation area 215 of the first touch electrode TE.

In some examples, the first touch electrode 110 may include various conductive materials, for example, a transparent conductive material, as a detailed example, conductive oxide. The touch electrode 110 may also include a metal material.

The first touch electrode TE may include a plurality of first extension areas 211 and a plurality of second extension areas 212 in a mesh structure, for example, may include first extension areas 211 and second extension areas 212 that are electrically connected to each other to form a mesh structure.

In some embodiments, external light may be reflected in at least one area when the external light is incident on the first extension area 211 and the second extension area 212, for example, may be reflected in an area adjacent to an edge and recognized by the user. The possibility may increase that the reflected light is more generated when there is an irregular arrangement in the regular mesh-shaped arrangement.

In some embodiments, reflection might not occur and reflected external light might not be recognized in the plurality of separation areas 215. The areas where no external light reflection occurs may act as irregular disconnections (interruptions) in terms of reflection characteristics through the regular mesh-shaped structure, and the user may sense spot patterns when external light is reflected. In the embodiment disclosed herein, the separation area 215 may be formed adjacent to the connection area 213 or in an area of the connection area 213 to reduce or suppress the generation of spots due to external light. For example, the connection area 213 may be an area where external light is not reflected well when incident, compared to the first extension area 211 and the second extension area 212. Accordingly, the connection area 213 may exhibit low external light reflection visibility. The connection area 113 may be an area with a regular arrangement in the mesh structure.

Therefore, when the separation area 215 is adjacent to the connection area 213 or corresponds to the connection area 113, the occurrence of spots, which is caused by the disconnection of the external light reflection area in the first extension area 211 and the second extension area 212 due to the separation area 215, may be reduced or suppressed.

The connection area 213 may also include a curved portion 213C, and the separation area 215 may correspond to the curved portion 213C or, as an example, may correspond to a partial area of the curved portion 213C. The curved portion 213C may be an area with low external light reflection visibility because there are many portions where external light is mixed with reflected light and disappears when the external light is incident and reflected. The separation area 215 may be arranged in the area, i.e., the curved portion 113C, thereby reducing or suppressing the occurrence of spots due to uneven external light reflection, which is caused by the separation area 215.

In an example, in case of arranging the plurality of separation areas 215, the curved portion 213C may be arranged in an area opposing each of the plurality of separation areas 215. For example, on the basis of the first extension areas 211 opposing each other or the second extension areas 212 opposing each other, the curved portion 213C may be arranged in an area opposite to one separation area 215, and as an optional embodiment, another separation area 215 may be formed in the corresponding area. This configuration may reduce or suppress the occurrence of spots, which is caused by uneven external light reflection interruption due to the separation area 215 when external light is reflected in the mesh-shaped first touch electrode TE having the regular structure.

As an example, the display apparatus 100 may be configured such that a plurality of unit areas are repeatedly arranged, and this may be different from the previous example in view of the position of the separation area 215.

In this instance, the position of the separation area 215 arranged in each unit area may be the same as the position of the separation area 215 in another unit area. As an optional embodiment, in this instance, the position of the separation area 215 arranged in each unit area may correspond to the position of the connection area 213 or the curved portion 213C of another unit area, and this description is substantially the same as that given in the above-described embodiment.

As an optional embodiment, the position of the separation area 215 arranged in each unit area may correspond to a position between the connection area 213 of another unit area and the first extension area 211 or the position between the connection area 213 and the second extension area 212, for example, to the position where the connection area 213 starts or ends.

With the configuration, on the basis of the entire screen of the display apparatus 200, the separation area 215 may be arranged in an area corresponding to or adjacent to the connection area 213 or curved portion 213C with very little or no external light reflection, thereby reducing or suppressing the occurrence of spots caused by uneven external light reflection interruption due to the separation area 115 when external light is reflected in the mesh-shaped first touch electrode TE having the regular structure.

The separation area 215 may be formed corresponding to the connection area 213 and may be formed in a thickness direction of the first extension area 211 or the second extension area 212 such that the width of the separation area 215 may be controlled not to increase.

In some embodiments, when the separation area 215 is formed in the connection area 213, the separation area 215 may be formed in an edge area, other than a middle area, of the curved portion 213C, for example, in an area of the curved portion 213C adjacent to the first extension area 211 or the second extension area 212. Accordingly, the separation area 215 may be located in an area of the curved portion 213C with low or no light reflection, thereby reducing uneven light reflection due to the separation area 215. Also, the width or length of the separation area 215 may be reduced, which may result in improving the electrical characteristics of the first touch electrode TE and enhancing the effect of reducing uneven light reflection.

A structure in which the touch electrode is tilted with respect to the emission area as illustrated in FIG. 3 may be selectively applied.

In some embodiments, as described above, the display apparatuses according to the disclosure may be applied to various fields, and this will be described in detail.

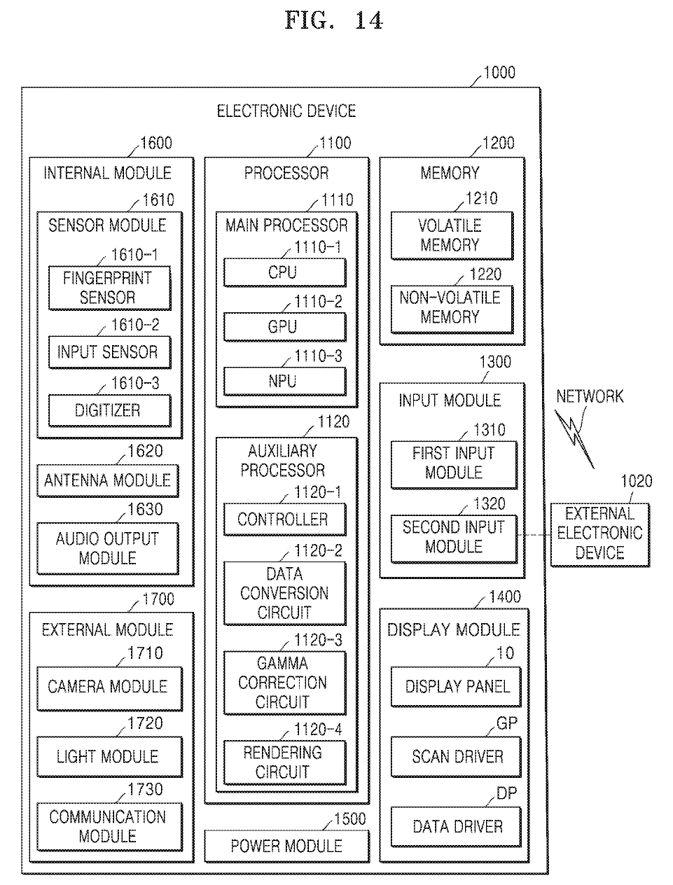

FIG. 14 is a block diagram of an electronic device according to embodiments. FIG. 14 illustrates an example, and the electronic device 1000 may selectively employ at least one or a plurality of components illustrated in FIG. 14 depending on the purpose and design conditions of the electronic device 1000.

An electronic device 1000 may output various types of information through a display module 1400 in an operating system. The display module 1400 may correspond to the display apparatus 100 or 200 or the display module DAU of the aforementioned embodiments, or at least a portion of the display apparatus 100 or 200 or the display module DAU.

Also, the touch sensing unit TPU or the touch electrode 100, 200 of the display module 1400 may be included in a sensor module 1610, and, as described below, the sensor module 1610 may be included in the display module 1400 or formed integrally with the display module 1400.

When a processor 1100 executes an application stored in a memory 1200, the display module 1400 may provide application information to a user through a display panel 10.

The processor 1100 may obtain an external input through an input module 1300 or the sensor module 1610 and execute an application corresponding to the external input. For example, when the user selects a camera icon displayed on the display panel 10, the processor 1100 may acquire a user input through an input sensor 1610-2, for example, the touch sensing unit of the aforementioned embodiment, and activate a camera module 1710. The processor 1100 may transmit image data, which corresponds to a photographed image acquired through the camera module 1710, to the display module 1400. The display module 1400 may display an image corresponding to the photographed image through the display panel 10.

As an example, when personal information authentication is performed in the display module 1400, a fingerprint sensor 1610-1 may acquire input fingerprint information as input data. The processor 1100 may compare the input data acquired through the fingerprint sensor 1610-1 with authentication data stored in the memory 1200, and execute an application based on a result of the comparison. The display module 1400 may display information executed according to a logic of the application through the display panel 10.

As an example, when a music streaming icon displayed on the display module 1400 is selected, the processor 1100 may obtain a user input through the input sensor 1610-2 and activate a music streaming application stored in the memory 1200. When a music execution command is input in the music streaming application, the processor 1100 may activate an audio output module 1630 to provide the user with audio information corresponding to the music execution command.

So far, the operation of the electronic device 1000 has been briefly described. Hereinafter, the configuration of the electronic device 1000 will be described in detail. Some of components of the electronic device 1000 to be described below may be provided as one integrated component, and a single component may also be separated and provided as two or more components.

Referring to FIG. 14, the electronic device 1000 may communicate with an external electronic device 1020 via a network (e.g., a short-range wireless communication network or a long-range wireless communication network). According to an embodiment, the electronic device 1000 may include a processor 1100, a memory 1200, an input module 1300, a display module 1400, a power module 1500, an internal module 1600, and an external module 1700. According to an embodiment, the electronic device 1000 may exclude at least one of the components, or may additionally include at least one other component. In an embodiment, some of the components described above (e.g., the sensor module 1610, the antenna module 1620, or the audio output module 1630) may be integrated into another component (e.g., the display module 1400).

The processor 1100 may execute software to control at least one other component (e.g., a hardware or software component) of the electronic device 1000 connected to the processor 1100, and perform various data processing or calculations. According to an embodiment, as at least some of the data processing or calculations, the processor 1100 may store commands or data received from another component (e.g., the input module 1300, the sensor module 1610, or a communication module 1730) in a volatile memory 1210, process the commands or data stored in the volatile memory 1210, and store resultant data in a non-volatile memory 1220.

The processor 1100 may include a main processor 1110 and an auxiliary processor 1120. The main processor 1110 may include one or more of a central processing unit (CPU) 1110-1 or an application processor (AP). The main processor 1110 may further include one or more of a graphics processing unit (GPU) 1110-2, a communication processor (CP), or an image signal processor (ISP). The main processor 1110 may further include a neural processing unit (NPU) 1110-3. The NPU 1110-3 may be a processor specialized in processing an artificial intelligence model, and the artificial intelligence model may be created through machine learning. The artificial intelligence model may include a plurality of artificial neural network layers. An artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the networks, but is not necessarily limited to the examples described above. The artificial intelligence model may additionally or alternatively include a software structure in addition to a hardware structure. At least two of the processing units and processors described above may be implemented as a single integrated configuration (e.g., a single chip) or may be implemented as independent configurations (e.g., a plurality of chips).

The auxiliary processor 1120 may include a controller 1120-1. The controller 1120-1 may include an interface conversion circuit and a timing control circuit. The controller 1120-1 may receive an image signal from the main processor 1110, and output image data by converting a data format of the image signal to comply with an interface specification with the display module 1400. The controller 1120-1 may output various control signals, which are required for operation of the display module 1400.

The auxiliary processor 1120 may further include the controller 1120-1, a data conversion circuit 1120-2, a gamma correction circuit 1120-3, a rendering circuit 1120-4, and the like. The data conversion circuit 1120-2 may receive image data from the controller 1120-1, and compensate for the image data so that the image is displayed at a desired brightness according to the characteristics of the electronic device 1000 or user settings, or may convert the image data to reduce power consumption or compensate for afterimages. The gamma correction circuit 1120-3 may convert image data or a gamma reference voltage, so that an image displayed on the electronic device 1000 has desired gamma characteristics. The rendering circuit 1120-4 may receive image data from the controller 1120-1 and render the image data by taking into consideration a pixel arrangement of the display panel 10 applied to the electronic device 1000. At least one of the data conversion circuit 1120-2, the gamma correction circuit 1120-3, or the rendering circuit 1120-4 may be integrated into another component (e.g., the main processor 1110 or the controller 1120-1). At least one of the data conversion circuit 1120-2, the gamma correction circuit 1120-3, or the rendering circuit 1120-4 may be integrated into a data driver 1430 to be described later.

The memory 1200 may store various kinds of data used by at least one component of the electronic device 1000 (e.g., the processor 1100 or the sensor module 1610), and input data or output data for commands related to the various kinds of data. The memory 1200 may include at least one of a volatile memory 1210 or a non-volatile memory 1220.

The input module 1300 may receive commands or data to be used in a component of the electronic device 1000 (e.g., the processor 1100, the sensor module 1610, or the audio output module 1630) from the exterior of the electronic device 1000 (e.g., the user or the external electronic device 1020).

The input module 1300 may include a first input module 1310 into which a command or data is input from the user, and a second input module 1320 into which a command or data is input from the external electronic device 1020. The first input module 1310 may include a microphone, a mouse, a keyboard, keys (e.g., buttons), or a pen/stylus (e.g., a passive pen/stylus or an active pen/stylus). The second input module 1320 may support a designated protocol that may be connected wiredly or wirelessly with the external electronic device 1020. According to an embodiment, the second input module 1320 may include a high definition multimedia interface (HDMI), a universal serial bus (USB) interface, an SD card interface, or an audio interface. The second input module 1320 may include a connector that may be physically connected to the external electronic device 1020, for example, an HDMI connector, a USB connector, an SD card connector, or an audio connector (e.g., a headphone connector).

The display module 1400 may provide information visually to the user. The display module 1400 may include a display panel 10, a scan driver GP, and a data driver DP.

The display module 1400 or the display panel 10 described in FIG. 14 may correspond to the display module DAU or the display panel DPP of the aforementioned embodiment.

The display panel 10 may further include an emission driver. The emission driver may output an emission control signal to the display panel 10, in response to a control signal received from the controller 1120-1. The emission driver may be formed separately from the scan driver GP or may be integrated into the scan driver GP.

The scan driver GP may receive a control signal from the controller 1120-1, and output scan signals to the display panel 10, in response to the control signal.

The data driver DP may receive a control signal from the controller 1120-1, convert image data into analog voltages (e.g., data voltages), in response to the control signal, and output the data voltages to the display panel 10.

The data driver DP may be integrated into another component (e.g., the controller 1120-1). The functions of the interface conversion circuit and the timing control circuit of the controller 1120-1 may also be integrated into the data driver DP.

The display module 1400 may further include an emission driver, a voltage generation circuit, and the like. The voltage generation circuit may output various voltages required for driving the display panel 10.

The power module 1500 may supply power to respective components of the electronic device 1000. For example, the power module 1500 may generate a first voltage ELVDD and a second voltage ELVSS. The power module 1500 may generate a gate driving voltage (e.g., gate high voltage, gate low voltage) required to drive the scan driver GP.

For example, the power module 1500 may refer to a power generation unit, a power supply, or the like. In some embodiments, the power module 1500 may include a battery that charges a power voltage. The battery may include a non-rechargeable primary battery, a rechargeable secondary battery, or a fuel cell.

For example, the power module 1500 may include a power management integrated circuit (PMIC). The PMIC may supply power optimized for each of the modules described above and modules to be described later.

The power module 1500, for example, may include a wireless power transmission and reception device electrically connected to the battery. The wireless power transmission and reception device may include a plurality of coil-shaped antenna radiators.

The electronic device 1000 may further include an internal module 1600 and an external module 1700. The internal module 1600 may include a sensor module 1610, an antenna module 1620, and an audio output module 1630. The external module 1700 may include a camera module 1710, a light module 1720, and a communication module 1730.

The sensor module 1610 may sense input by the user's body or input by a pen/stylus of the first input module 1310, and generate an electric signal or data value in response to the input. The sensor module 1610 may include at least one of a fingerprint sensor 1610-1, an input sensor 1610-2, or a digitizer 1610-3.

The fingerprint sensor 1610-1 may generate a data value corresponding to the user's fingerprint. The fingerprint sensor 1610-1 may include any one of an optical fingerprint sensor or a capacitive fingerprint sensor.

The input sensor 1610-2 may generate a data value corresponding to coordinate information about input by the user's body or input by the pen/stylus. The input sensor 1610-2 may generate a data value based on the change in capacitance due to input. The input sensor 1610-2 may also sense input by a passive pen/stylus or transmit and receive data to and from an active pen/stylus.

The input sensor 1610-2 may also measure a bio-signal, such as blood pressure, moisture, or body fat. For example, when the user does not move for a certain period of time while touching a portion of his or her body to a sensor layer or sensing panel, the input sensor 1610-2 may detect a bio-signal based on a change in electric field caused by the portion of his or her body, and output information desired by the user to the display module 1400.

The digitizer 1610-3 may generate a data value corresponding to coordinate information input by the pen/stylus. The digitizer 1610-3 may generate a data value based on an electromagnetic change by input. The digitizer 1610-3 may detect input by the passive pen/stylus or transmit and receive data to and from the active pen/stylus.

The touch sensing unit TPU or the touch electrode 100, 200 of the aforementioned embodiments may be included in the sensor module 1610, and as an example, may be included in at least one of the fingerprint sensor 1610-1, the input sensor 1610-2, or the digitizer 1610-3, and as a specific example, may correspond to the input sensor 1610-2.

At least one of the fingerprint sensor 1610-1, the input sensor 1610-2, or the digitizer 1610-3 may be implemented as a sensor layer formed on the display panel 10 through a continuous process. The fingerprint sensor 1610-1, the input sensor 1610-2, and the digitizer 1610-3 may be arranged on the display panel 10, and any one of the fingerprint sensor 1610-1, the input sensor 1610-2, or the digitizer 1610-3, for example, the digitizer 1610-3, may be arranged below the display panel 10.

In some embodiments, as described above, the touch sensing unit TPU may be arranged on the display panel DP, and in this instance, as an optional embodiment, the touch sensing unit TPU may be arranged on the encapsulation portion TFE.

At least two of the fingerprint sensor 1610-1, the input sensor 1610-2, or the digitizer 1610-3 may be integrated into a single sensing panel through the same process. In case of being integrated into a single sensing panel, the sensing panel may be arranged on the display panel 10, or as an example, may be arranged on a window arranged on the upper side of the display panel 10. The position of the sensing panel may be variously determined by controlling the conditions of other manufacturing processes.

As an optional embodiment, at least one of the fingerprint sensor 1610-1, the input sensor 1610-2, or the digitizer 1610-3 may be embedded in the display panel 10. For example, at least one of the fingerprint sensor 1610-1, the input sensor 1610-2, or the digitizer 1610-3 may be formed simultaneously through a process of forming devices (e.g., light-emitting devices, transistors, or the like) included in the display panel 10.

In some embodiments, the sensor module 1610 may generate an electrical signal or data value corresponding to an internal or external state of the electronic device 1000. The sensor module 1610 may further include, for example, a gesture sensor, a gyro sensor, an air pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 1620 may include one or more antennas for transmitting signals or power to or receiving signals or power from the exterior. According to an embodiment, the communication module 1730 may transmit a signal to an external electronic device or receive a signal from the external electronic device through an antenna suitable for a communication method. An antenna pattern of the antenna module 1620 may be integrated into one component of the display module 1400 (e.g., the display panel 10) or the input sensor 1610-2.

The audio output module 1630 may be a device for outputting audio signals to the outside of the electronic device 1000, and may include, for example, a speaker used for general purposes, such as playing multimedia or playing record, and a receiver used exclusively for incoming calls. According to an embodiment, the receiver may be formed integrally with or separately from the speaker. An audio output pattern of the audio output module 1630 may also be integrated into the display module 1400.

The camera module 1710 may photographs still images and moving images (videos). According to an embodiment, the camera module 1710 may include at least one of a lens, an image sensor, or an image signal processor. The camera module 1710 may further include an infrared camera which may measure presence or absence of a user, the user's location, the user's gaze, and the like.

The light module 1720 may provide light. The light module 1720 may include a light-emitting diode or a xenon lamp. The light module 1720 may operate in conjunction with the camera module 1710 or independently.

The communication module 1730 may support establishment of a wired or wireless communication channel between the electronic device 1000 and the external electronic device 1020, and performance of communication through the established communication channel. The communication module 1730 may include one or all of a wireless communication module, such as a cellular communication module, a short-range wireless communication module, or a global navigation satellite system (GNSS) communication module, and a wired communication module, such as a local area network (LAN) communication module, or a power line communication module. The communication module 1730 may communicate with the external electronic device 1020 via a short-range communication network, such as Bluetooth, WiFi direct, or infrared data association (IrDA), or a long-range communication network, such as a cellular network, the Internet, or a computer network (e.g., a LAN or WAN). The various types of communication modules 1730 described above may be implemented as one chip or as separate chips.

The input module 1300, the sensor module 1610, the camera module 1710, and the like may be used to control the operation of the display module 1400 in conjunction with the processor 1100.

The processor 1100 may output a command or data to the display module 1400, the audio output module 1630, the camera module 1710, or light module 1720 based on input data received from the input module 1300. For example, the processor 1100 may generate image data in response to input data received through a mouse, an active pen/stylus, or the like, and output the generated image data to the display module 1400, or may generate command data in response to the input data and output the generated command data to the camera module 1710 or the light module 1720. When no input data is received from the input module 1300 for a certain period of time, the processor 1100 may switch an operation mode of the electronic device 1000 to a low-power mode or sleep mode to reduce power consumption of the electronic device 1000.

The processor 1100 may output a command or data to the display module 1400, the audio output module 1630, the camera module 1710, or the light module 1720 based on sensing data received from the sensor module 1610. For example, the processor 1100 may compare authentication data applied by the fingerprint sensor 1610-1 with authentication data stored in the memory 1200, and execute an application based on a result of the comparison. The processor 1100 may execute a command or output corresponding image data to the display module 1400 based on sensing data detected by the input sensor 1610-2 or the digitizer 1610-3. When a temperature sensor is included in the sensor module 1610, the processor 1100 may receive temperature data on a measured temperature from the sensor module 1610, and further perform brightness correction or the like on image data based on the temperature data.

The processor 1100 may receive measurement data on the presence or absence of a user, the user's location, the user's gaze, and the like from the camera module 1710. The processor 1100 may further perform brightness correction and the like on image data based on the measurement data. For example, the processor 1100 which has determined the presence or absence of the user through input from the camera module 1710 may output image data, which has brightness corrected through the data conversion circuit 1120-2 or the gamma correction circuit 1120-3, to the display module 1400.

Some of the components may be connected to each other through a communication method between peripheral devices, such as a bus, general purpose input/output (GPIO), serial peripheral interface (SPI), mobile industry processor interface (MIPI), or ultra path interconnect (UPI) link, to exchange signals (e.g., commands or data) with each other. The processor 1100 may communicate with the display module 1400 through a mutually agreed interface, and for example, may use any one of the aforementioned communication methods, and the communication method is not necessarily limited to the aforementioned communication methods.

The electronic device 1000, according to various embodiments disclosed herein, may be various type of devices. The electronic device 1000 may include, for example, at least one of a portable communication device (e.g., a smartphone), a computer device, a portable multimedia device, a portable medical device, a digital camera, a wearable device, or a home appliance device. The electronic device 1000, according to an embodiment, is not necessarily limited to the devices described above.

Hereinafter, an implementation of the electronic device 1000 will be described in detail.

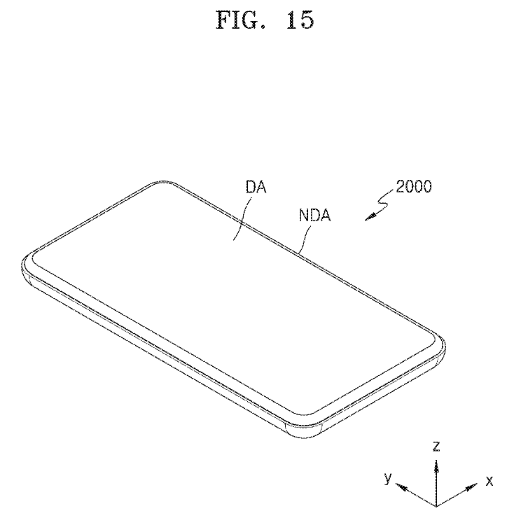

FIG. 15 is a view illustrating an electronic device to which a display apparatus according to an embodiment is applied.

The aforementioned display apparatus, for example, the display apparatus 100 or the display apparatus 200, may be applied to various electronic devices.

For example, the display apparatus 100 or the display apparatus 200 of the above-described embodiments may be various products or parts thereof, such as a television, a laptop/notebook computer, a computer monitor, a digital billboard, the Internet of Things device, as well as portable electronic devices, such as a mobile phone, a smartphone, a tablet computer, a mobile communication terminal, an electronic organizer, an electronic book, a portable multimedia player (PMP), a navigation, and an ultra-mobile PC (UMPC).

The display apparatus 100 or the display apparatus 200 of the aforementioned embodiments may also be wearable devices or parts thereof, such as a smart watch, a watch phone, a glasses-type display, or a head mounted display (HMD).

The disclosure is not necessarily limited thereto. For example, the display apparatus 100 or 200 of the embodiments described above may be included in a dashboard of a vehicle, a center information display (CID) arranged on a center fascia or dashboard of a vehicle, a room mirror display replacing a side mirror of a vehicle, a display arranged on the rear side of a front seat to serve as an entertainment device for back seat passengers of a vehicle, a head-up display (HUD) installed on the front of a vehicle or projected on front window, and a computer-generated hologram augmented reality head-up display (CGH AR HUD).

For example, referring to FIG. 15, an example is illustrated in which an electronic device 2000 to which the display apparatus 100 or 200 of the above-described embodiments is applied is a smart phone.

The electronic device 2000 may include a display area DA and a peripheral area NDA outside the display area DA. The display area DA of the electronic device 2000 may overlap the display area DA of the display apparatus 200 described above, or as an example, may be partially obscured by the display area DA of the display apparatus 200. The peripheral area NDA of the electronic device 2000 may be an area where an image is not displayed, and may be an area that overlaps fully or partially the peripheral area NDA of the display apparatus 200. Drivers for applying electrical signals or power to display component arranged in the display area DA may be arranged in the peripheral area NDA of the electronic device 2000, and pads which are areas to which electronic components or printed circuit boards may be electrically connected, may also be arranged in the peripheral area NDA of the electronic device 2000. The electronic device 2000 that is the smart phone may be of a rigid type, or as an example, may include various types, such as a bending type in which one or opposite sides are bent, or a foldable type in which the device is folded more than once.

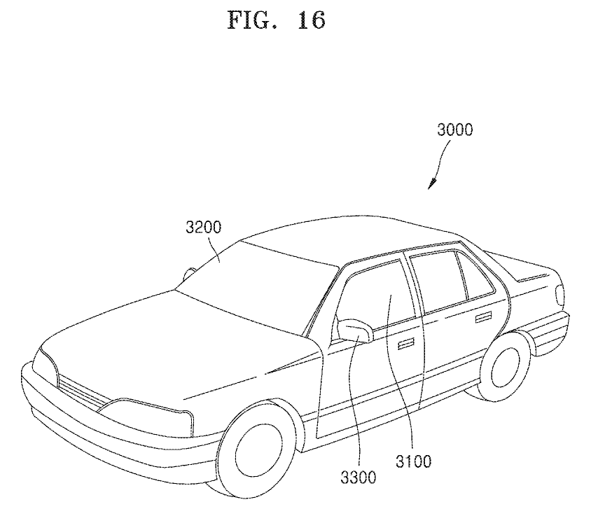

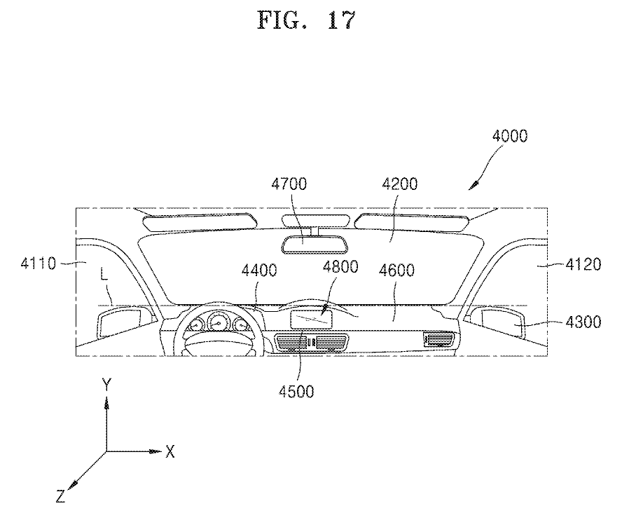

FIGS. 16 and 17 are views illustrating an electronic device to which a display apparatus according to an embodiment is applied.

FIG. 16 is a schematic view of the exterior of transport device 3000 to which a display apparatus is applied, as a specific example.

The transport device 3000 may refer to various devices for moving a target to be transported, such as a human, an object, or an animal, and may include a vehicle traveling on a road or a track, a vessel moving over the sea or river, and an airplane flying in the sky using the action of air.

The transport device 3000 may also move in a certain direction according to rotation of at least one wheel. For example, the transport device 3000 may include a three-wheeled or four-wheeled vehicle, a construction machine, a two-wheeled vehicle, a motor device, a bicycle, and a train running on a track.

The transport device 3000 may include a body having an interior and an exterior, and a remaining part except for the body, for example, a chassis in which mechanical devices necessary for traveling are installed. The exterior of the body may include a pillar arranged at a boundary between a front panel, a hood, a roof panel, a rear panel, a trunk, and a door.

The chassis of the transport device 3000 may include a power generation device, a power transmission device, a traveling device, a steering device, a braking device, a suspension device, a transmission device, a fuel device, left and right wheels at the front and rear, and the like.

The transport device 3000 may include side window 3100, front window 3200, and a side mirror 3300.

The display apparatus 100 or 200 of the above-described embodiments may be applied to one area of the transport device 3000, for example, one of the side window 3100, the front window 3200, and the side mirror 3300. A user, for example, a driver or passenger of the transport device, may visually check information inside the transport device 3000 through one of the side window 3100, the front window 3200, and the side mirror 3300. The user may also perform a touch operation to input desired information, and proceed touch sensing and information processing through a touch sensing unit. Alternatively, even outside the transport device, for example, a vehicle, the driver or passenger or persons outside the vehicle may view various information displayed on the transport device 3000.

FIG. 17 is a schematic view of the interior of a transport device 4000 to which the display apparatus is applied, as a detailed example.

The transport device 4000 may include therein a cluster 4400, a center fascia 4500, and a passenger-seat dashboard 4600.

The transport device 4000 may also include side windows, and the side windows may include first side window 4110 and second side window 4120.

One or more side mirrors 4300 may be included in the transport device 4000. The cluster 4400 may be located in front of a steering wheel. The cluster 4400 may include a tachometer, speedometer, a coolant thermometer, a fuel gauge indicator light, a high beam indicator light, a warning light, a seat belt warning light, a trochometer, an odometer, an automatic shift selection lever indicator light, a door open warning light, an engine oil warning light, and/or a low fuel warning light.

The center fascia 4500 may include a control panel on which a plurality of buttons for controlling an audio device, an air conditioning device, and a seat heater are located. The center fascia 4500 may be arranged on one side of the cluster 4400.

The passenger-seat dashboard 4600 may be arranged on one side of the center fascia 4500.

The display apparatus 100 or 200 of the above-described embodiments may be applied to one area of the transport device 4000, for example, one or more of the cluster 4400, the center fascia 4500, or the passenger-seat dashboard 4600, and, as an example, to a rear mirror portion 4700. Accordingly, the user, for example, the driver or passenger of the transport device 4000, may visually check information through one or more of the cluster 4400, the center fascia 4500, the passenger-seat dashboard 4600, or the rear mirror portion 4700 inside the transport device 4000, perform a touch operation for an input such as information checking, and perform touch sensing and information processing through the touch sensing unit.

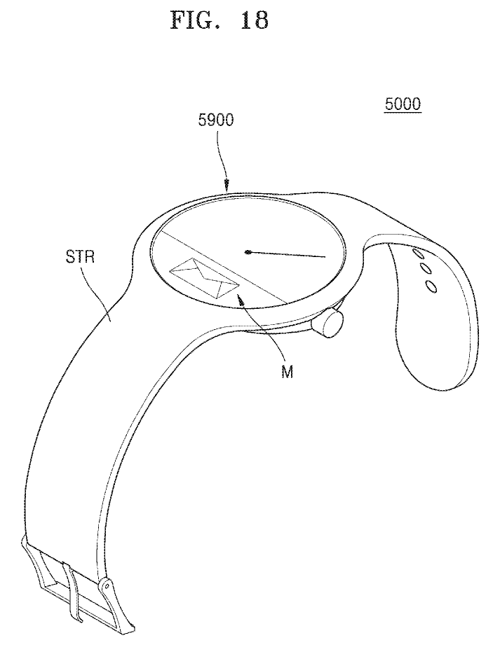

FIG. 18 is a view illustrating an electronic device to which a display apparatus according to an embodiment is applied.

The above-described display apparatus, for example, the display apparatus 100 or 200, may be applied to various electronic devices, for example, an electronic device carried or worn by a user, as a detailed example, a wearable device.

Referring to FIG. 18, in one example, the electronic device may be a wearable electronic device 5000, and as a detailed example, may be a smart watch.

The wearable electronic device 5000 may include a main body 5900 and a stationary part STR (or strap). The main body 5900 may display an image IM having certain information.

The image IM may be implemented through the aforementioned display apparatus 100 or 200, and, for example, may be implemented using light emitted from at least one emission area. An area where the image IM is displayed may include an area where a user's touch is sensed, i.e., an area where a touch sensing unit having a touch electrode is arranged. Through this, the user may check the image IM on the main body 5900 while wearing or carrying the wearable electronic device 5000 or perform an input operation by applying a touch directly or using a touch pen/stylus. In some examples, the main body 5900 may include the aforementioned display apparatus 100 or 200.

The image IM may be an icon or execution screen of an application executed by an application processor as well as an image which realizes an existing analog clock, such as hands of a clock indicating a current time.

The main body 5900 may be detachably coupled to the stationary part STR. The user may wear the stationary part STR on his/her wrist to use the wearable electronic device 5000 on his/her wrist. The stationary part STR may have the shape of a strap, but is not necessarily limited to the purpose of being worn on the user's wrist. The stationary part STR may be of a type to be worn on the user's arm or the neck, or may be replaced with a cradle for mounting the main body 5900 to another electronic device.

A display apparatus and electronic device according to one or more embodiments may implement high-quality characteristics.

As such, the disclosure has been described with reference to embodiments shown in the drawings, but this is illustrative, and it will be understood by those of skilled in the art that various modifications and variations of the embodiment may be made.

What is claimed is:

1. A display apparatus, comprising:
a plurality of emission areas configured to emit light, and a touch electrode configured to sense a user's touch,
wherein the touch electrode comprises:
a first extension area extending primarily in a first direction;
a second extension area extending primarily in a second direction, crossing the first direction;
a connection area in which the first extension area and the second extension area are connected to each other; and
a separation area, free of a material of the touch electrode, the separation area being closer to the connection area than to a center of the first extension area or the second extension area in a longitudinal direction of the first extension area or the second extension area.

2. The display apparatus of claim 1, wherein
the separation area is disposed between either the first extension area or the second extension area, and the connection area.

3. The display apparatus of claim 1, wherein
the separation area is disposed in the connection area.

4. The display apparatus of claim 1, wherein
the connection area comprises a curved portion.

5. The display apparatus of claim 4, wherein
the separation area overlaps at least area portion of the curved portion.

6. The display apparatus of claim 5, wherein
the connection area is provided in plural, and
the connection area comprises a curved portion formed to oppose the separation area which overlaps the curved portion.

7. The display apparatus of claim 1, wherein
the touch electrode has a mesh shape that corresponds to a periphery of each of the plurality of emission areas.

8. A display apparatus, comprising:
a display panel and a touch sensing unit,
wherein the display panel comprises at least one display components configured to generate an image,
wherein the touch sensing unit comprises a touch electrode configured to sense a touch, and
wherein the touch electrode comprises:
a first extension area extending primarily in a first direction;
a second extension area extending primarily in a second direction crossing the first direction;
a connection area in which the first extension area and the second extension area are connected to each other; and
a separation area, free of a material of the touch electrode, the separation area being: (i) closer to the connection area than to a center of the first extension area; or (ii) the second extension area in a longitudinal direction of the first extension area or the second extension area.

9. The display apparatus of claim 8, wherein
the separation area is disposed between either the first extension area or the second extension area, and the connection area.

10. The display apparatus of claim 8, wherein
the separation area is disposed in the connection area.

11. The display apparatus of claim 8, wherein
the connection area comprises a curved portion.

12. The display apparatus of claim 11, wherein
the separation area overlaps the curved portion.

13. The display apparatus of claim 12, wherein
the connection area is provided in plural, and
the connection area comprises a curved portion opposite to the separation area, which overlaps the curved portion.

14. The display apparatus of claim 8, wherein
the touch electrode has a mesh shape corresponding to a periphery of each of a plurality of emission areas of the display panel.

15. The display apparatus of claim 8, wherein
the touch sensing unit is disposed on the display panel.

16. An electronic device, comprising:
a processor configured to execute at least one application by sensing an external input through a sensor module; and
a display panel configured to display at least one image by the control of the processor,
wherein the display panel comprises at least one display component configured to generate an image,
wherein the sensor module comprises a touch sensing unit configured to sense a touch,
wherein the touch sensing unit comprises a touch electrode configured to sense the touch, and
wherein the touch electrode comprises a first extension area extending primarily in a first direction, a second extension area extending primarily in a second direction crossing the first direction, a connection area in which the first extension area and the second extension area are connected to each other, and a separation area, free of a material of the touch electrode, the separation area being closer to the connection area than to either a center of the first extension area or the second extension area in a longitudinal direction of the first extension area or the second extension area.

17. The electronic device of claim 16, wherein
the separation area is disposed between either the first extension area or the second extension area, and the connection area.

18. The electronic device of claim 16, wherein
the separation area is disposed in the connection area.

19. The electronic device of claim 16, wherein
the connection area comprises a curved portion.

20. The electronic device of claim 16, wherein
the touch sensing unit is disposed on the display panel.
